(19) United States
(12) Patent Application Publication
(10) Pub. No.: US 2024/0021957 A1
(43) Pub. Date: Jan. 18, 2024

(54) BATTERY SEPARATORS COMPRISING RIBS

(71) Applicant: Hollingsworth & Vose Company, East Walpole, MA (US)

(72) Inventors: Mahadevaswamy Kodimole Mahadevappa, Chamarajanagar (IN); Girisha Basavaraju, Karnataka (IN); Krishna Marchigowda, Karnataka (IN); Kameswara Rao Patchigolla Venkata, Kanakadasa Nagar (IN); Nagendra Anantharamaiah, Acton, MA (US); Ganesha Maduvinakodi Narasimhamurthy, Mysuru (IN); Manu Patel Mruthunjayappa, Shimoga (IN)

(73) Assignee: Hollingsworth & Vose Company, East Walpole, MA (US)

(21) Appl. No.: 18/265,240

(22) PCT Filed: Dec. 6, 2021
(86) PCT No.: PCT/US2021/061987

§ 371 Date: Jun. 2, 2023

(30) Foreign Application Priority Data
Dec. 7, 2020 (IN) 202011053238

(51) Int. Cl. H01M 50/463; H01M 50/457; H01M 50/446; H01M 50/454; H01M 50/417; H01M 50/491; H01M 50/44; H01M 50/437; H01M 50/426; H01M 10/12

(52) U.S. Cl. CPC H01M 50/463; H01M 50/457; H01M 50/446; H01M 50/454; H01M 50/417; H01M 50/491; H01M 50/44; H01M 50/437; H01M 50/426; H01M 10/121

(57) ABSTRACT

Battery separators comprising ribs are generally described. In some embodiments, the ribs have one or more features that enhance the performance of the battery separator.

### FIELD

The present invention relates generally to battery separators, and, more particularly, to battery separators comprising ribs.

### BACKGROUND

Battery separators may be employed in a variety of applications to prevent direct contact between electrodes. Some battery separators include ribs. However, some ribs exhibit undesirable thermal instability and/or have structures that allow for undesirably low electrolyte diffusion.

Accordingly, improved battery separator designs are needed.

### SUMMARY

Battery separators, related components, and related methods are generally described.

In some embodiments, a battery separator is provided. The battery separator comprises a porous layer and a plurality of ribs disposed on the porous layer. The ribs comprise a polymer, the ribs comprise a filler, and the plurality of ribs forms a discrete component of the battery separator.

In some embodiments, a battery separator comprises a porous layer and a plurality of ribs disposed on the porous layer. The ribs exhibit a mass loss of less than or equal to 2% upon exposure to a temperature of 160° C. for 13 minutes and the plurality of ribs forms a discrete component of the battery separator.

In some embodiments, a battery separator comprises a porous layer and a plurality of ribs disposed on the porous layer. The ribs are porous and the plurality of ribs forms a discrete component of the battery separator.

In some embodiments, a method is provided. The method comprises passing a fluid comprising a polymer through a screen comprising a plurality of orifices onto a porous layer and cooling the fluid to form ribs comprising the polymer disposed on the porous layer.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a battery separator comprising a plurality of ribs, in accordance with some embodiments;

FIG. 2 shows a battery separator comprising a first porous layer and a second porous layer, in accordance with some embodiments;

FIG. 3 shows a battery separator comprising a first plurality of ribs and a second plurality of ribs on a side of the battery separator opposite that on which the first plurality of ribs is disposed, in accordance with some embodiments;

FIG. 4 shows a method of passing a fluid through a screen onto a porous layer, in accordance with some embodiments;

FIG. 5 shows flow of a fluid through a rotating cylindrical screen that is deposited onto a porous layer translating therebeneath, in accordance with some embodiments;

FIG. 6 shows micrographs of ribs after exposure to heat, in accordance with some embodiments;

FIG. 7 shows micrographs of ribs after exposure to sulfuric acid, in accordance with some embodiments;

FIG. 8 is a chart showing the amount of iron leached into an electrolyte from two pluralities of ribs, in accordance with some embodiments;

FIG. 9 is a chart showing C20, C10, and C1 capacities for batteries comprising different battery separators, in accordance with some embodiments;

FIGS. 10 and 11 show micrographs of battery separators, in accordance with some embodiments;

FIG. 12 is a chart showing the porosity of the battery separators as a function of the amount of pore-forming additive present in the fluid from which their ribs were formed, in accordance with some embodiments;

FIGS. 13 and 14 are charts showing the weight loss for battery separators upon exposure to oxidative fluids, in accordance with some embodiments;

FIG. 15 is a chart showing heat flow during differential scanning calorimetry analysis of various materials, in accordance with some embodiments; and

FIG. 16 is a chart showing the end of discharge voltage as a function of the number of cycles for various batteries, in accordance with some embodiments.

### DETAILED DESCRIPTION

Battery separators comprising ribs are generally described. In some embodiments, the ribs have one or more features that enhance the performance of the battery separator.

As one example, in some embodiments, a battery separator comprises ribs that comprise a polymer and a filler. Some fillers may enhance the thermal stability of the ribs in which they are positioned by serving as portions of the ribs that do not melt and/or degrade at temperatures typically experienced by the ribs. Some fillers may advantageously reduce the electrical resistance of the battery separator of which they form a part by serving as portions of the battery separator that have a relatively high dielectric constant.

As a second example, in some embodiments, a battery separator comprises ribs that are porous. The porosity may promote diffusion of electrolyte through the ribs and/or the battery separator, which may reduce the electrical resistance of the battery separator and/or may enhance ion mobility through the battery separator. In some embodiments, the presence of porosity in ribs may enhance one or more properties of a battery in which the battery separator is positioned. For instance, porosity may increase electrolyte availability between battery plates, enhance charge acceptance, and/or reduce electrical resistance across the battery as a whole.

As a third example, in some embodiments, a battery separator comprises ribs that are thermally stable. Such ribs may undergo minimal or no degradation and/or structural change when exposed to the heated conditions typically present during fabrication (e.g., during a cast on strap process) and/or operation (e.g., during cycling).

Some embodiments relate to methods of fabricating battery separators. A method of fabricating a battery separator may comprise passing a fluid through a screen comprising a plurality of orifices onto a porous layer. The fluid may then be cooled to form ribs comprising one or more components present in the fluid. Advantageously, this method may allow for the formation of ribs in a manner that is facile, rapid, and relatively inexpensive.

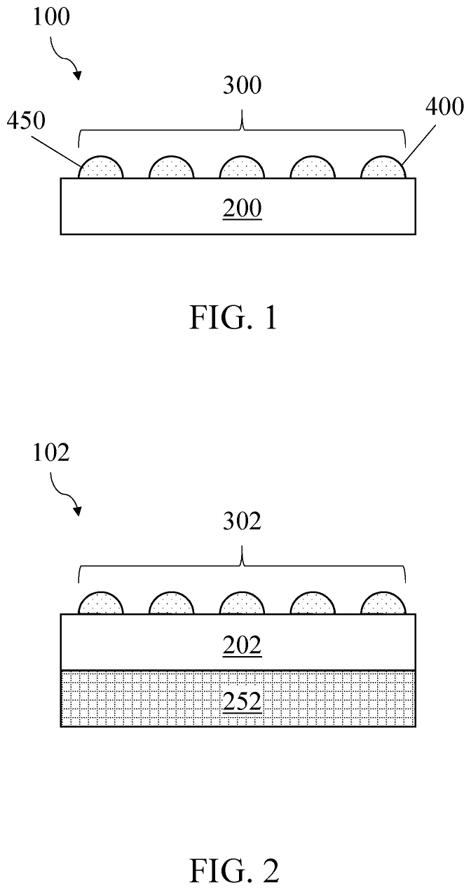

FIG. 1 shows one non-limiting embodiment of a battery separator comprising a plurality of ribs. In FIG. 1, the battery separator 100 comprises a porous layer 200 and a plurality of ribs 300 disposed on the porous layer. Some battery separators described herein, like that shown in FIG. 1, are leaf separators. It is also possible for a battery separator described herein to be a folded separator, a pocket separator, a z-fold separator, a sleeve separator, a corrugated separator, a C-wrap separator, or a U-wrap separator.

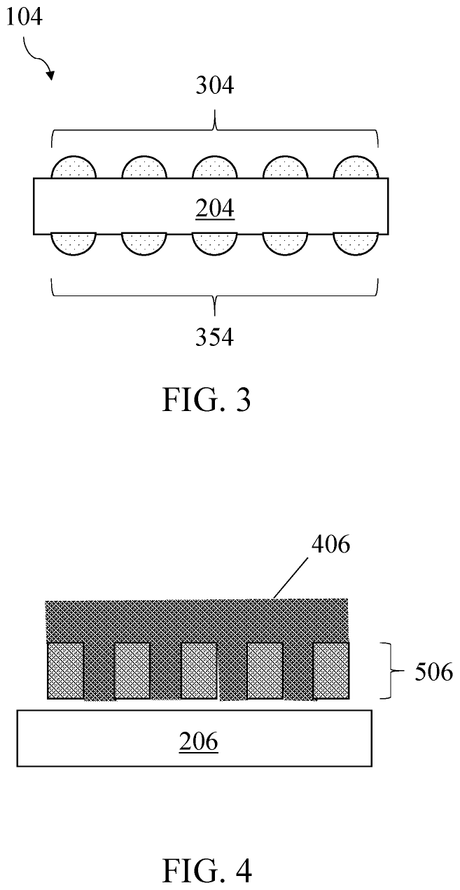

In some embodiments, like the embodiment shown in FIG. 1, a battery separator includes exactly one porous layer and includes a plurality of ribs on exactly one side thereof. It is also possible for a battery separator to include two or more porous layers (e.g., as shown in FIG. 2, which depicts a battery separator comprising a first porous layer 202 and a second porous layer 252) and/or to include ribs on two opposing sides thereof (e.g., as shown in FIG. 3, which depicts a battery separator comprising a first plurality of ribs 304 and a second plurality of ribs 354 on a side of the battery separator opposite that on which the first plurality of ribs is disposed). When a battery separator comprises two pluralities of ribs positioned on different surfaces thereof, the two pluralities of ribs may be mirror images of each other (e.g., as shown in FIG. 3) or may differ from mirror images of each other in one or more ways. For instance, pluralities of ribs positioned on opposing sides of a battery separator may have different shapes, have different repeat periods, be positioned at different locations, and/or have different compositions. In some embodiments, a battery separator comprises a first plurality of ribs on one side thereof that is suitable for being positioned adjacent to a negative electrode and a second plurality of ribs on an opposite side thereof that is suitable for being positioned adjacent to a positive electrode.

In some embodiments, a plurality of ribs forms a discrete component of a battery separator in which it is positioned. Discrete components of battery separators may be components that are clearly separate from any other components to which they are adjacent. For instance, a component of a battery separator that is a discrete component may be separated from other components of the battery separator to which it is adjacent by an interface. As another example, a component of a battery separator that is a discrete component may have a different chemical composition than other components of the battery separator to which it is adjacent and/or a different structure (e.g., porosity) than other components of the battery separator to which it is adjacent. As a third example, in some embodiments, a component of a battery separator that is a discrete component is not integrally connected to any other components of the battery separator and/or may be separable from other components of the battery separator (i.e., those it is discrete from) without the use of specialized tools. Some pluralities of ribs that are discrete components of battery separators may be layers that are not coextruded with any other layers (e.g., any porous layers in the battery separators).

Some pluralities of ribs described herein comprise at least two ribs that are not directly topologically connected by a material having the same composition as the ribs. In other words, for at least two ribs in the plurality of ribs, there may not exist any pathway therebetween that passes exclusively through portions of the battery separator formed from the same material as the ribs. With respect to FIG. 1, and in embodiments in which the porous layer shown in FIG. 1 has a different composition from the plurality of ribs shown in FIG. 1, the ribs 400 and 450 are not directly topologically connected by a material having the same composition as the ribs. As can be seen in FIG. 1, any pathway connecting the ribs 400 and 450 must pass outside the battery separator and/or through the porous layer having a different composition from these ribs.

The ribs described herein may have a variety of suitable designs. For instance, some pluralities of ribs may comprise continuous ribs (e.g., ribs lacking termini positioned at locations other than the edges of the surface of the battery separator on which they are positioned), some pluralities of ribs may comprise discontinuous ribs (e.g., ribs comprising termini positioned at locations other than the edges of the surface of the battery separator on which they are positioned), and some pluralities of ribs may comprise both continuous ribs and discontinuous ribs. Ribs, whether continuous or discontinuous, may comprise cross-sections having a variety of suitable shapes. Non-limiting examples of suitable cross-sections (e.g., in the plane parallel to the porous layer on which the ribs are disposed) include circular cross-sections, oval cross-sections, diamond cross-sections, rectangular cross-sections, square cross-sections, line segment cross-sections, and star cross-sections (e.g., five-pointed, six-pointed, seven-pointed, higher-pointed).

In some embodiments, a plurality of ribs (that may be continuous or discontinuous) has a structure that can be characterized by one or more symmetry operators. For instance, in some embodiments, a plurality of ribs has a structure that can be mapped relatively closely to a two-dimensional lattice, such as a two-dimensional lattice having rectangular symmetry, tetragonal symmetry, or hexagonal symmetry. The mapping may be sufficiently close such that the standard deviation of the centers of gravity of the ribs from the lattice points may be less than or equal to 10%, less than or equal to 5%, less than or equal to 2%, or less than or equal to 1% of the nearest neighbor distance of the lattice points. In some embodiments, a plurality of ribs comprises a structure that is periodic in one or two dimensions. For example, the plurality of ribs may comprise a waved structure and/or a sinusoidal structure. As another example, a plurality of ribs may comprise a structural motif that is repeated in one or two dimensions, non-limiting examples of which include diamonds and triangles.

As described elsewhere herein, some embodiments relate to methods for fabricating battery separators. The methods may comprise forming ribs on porous layers. In some embodiments, a method comprises forming ribs on a porous layer from a fluid comprising one or more components to be included in the ribs. The fluid may be disposed on the porous layer and then cooled to form the ribs. In some embodiments, the fluid is disposed on the porous layer by passing it through a screen comprising a plurality of orifices. A porous layer may be positioned on the opposing side of the screen, and may receive the fluid passed through the orifices. In some embodiments, the shape of the ribs may be influenced by and/or substantially the same as the shapes of the orifices through which the fluid passed.

FIG. 4 shows one non-limiting embodiment of a method of passing a fluid through a screen onto a porous layer. In FIG. 4, a fluid 406 is passed through a screen 506 onto a porous layer 206. As shown in FIG. 4, the fluid may pass through the orifices in a screen and/or the orifices in the screen may direct the fluid to deposit on the porous layer in select locations. The screens described herein may have a variety of suitable shapes. As one non-limiting example, in some embodiments, a screen has a shape that has a hollow center. The fluid may be fed into the hollow center and then passed outwardly through the screen. One example of a screen having this shape is a cylindrical screen.

For screens of any shape, a method may comprise removing (e.g., by scraping, by squeegeeing) excess amounts of a fluid to be passed through the screen from a side of the screen opposite a porous layer onto which the fluid is to be deposited. For instance, fluid may be supplied to the screen at a rate and/or in an amount that is larger than suitable for deposition onto the porous layer. Removing the excess fluid from the screen in such embodiments may assist with the deposition of the fluid onto the porous layer in a manner that is controlled and/or that results in the deposition of an appropriate amount of fluid having an appropriate morphology onto the porous layer. In embodiments in which fluid is passed through the screen from a hollow center outwards, the fluid removal may be performed on an interior surface of the screen. In other words, excess fluid may be removed from an interior of the screen.

In some embodiments, a method comprising passing a fluid through a screen onto a porous layer comprises moving the screen and/or the porous layer. Either or both of these movements may occur while fluid is passing through the screen. As one example, in some embodiments, a porous layer may be translated on a side of the screen opposing the fluid, such as beneath the screen, while fluid is being passed through the screen. As the porous layer translates, the fluid may be deposited onto different portions of the porous layer. In some such embodiments, the porous layer may be translated beneath the screen in a roll-to-roll manner. As another example, in some embodiments, the screen is rotated while fluid is being passed therethrough. For instance, a screen comprising a hollow center may be rotated around a hollow central axis. As the screen rotates, different portions of the screen may be positioned in different locations around the rotational axis. This may result in a flow through the screen that, for a particular position opposite the screen, varies over time. When the porous layer translates adjacent a rotating screen, the fluid may deposit such that it forms a spatially-varying pattern thereon.

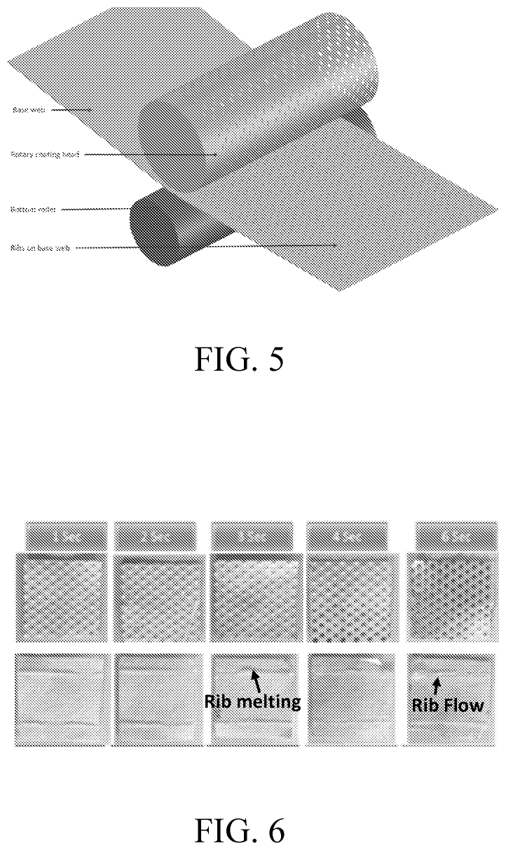

FIG. 5 shows one non-limiting example of flow of a fluid through a rotating cylindrical screen that is deposited onto a porous layer translating therebeneath. As can be seen from FIG. 5, as orifices and solid portions of the screen pass beneath the source of fluid flowing therethrough (not shown), the orifices allow fluid to flow through the screen and the solid portions of the screen block fluid flow therethrough. This causes portions of fluid to be deposited on the porous layer that are not topologically connected by a material having the same composition as the fluid. In FIG. 5, the porous layer is labeled as the “base web” and the screen is labeled as the “rotary coating head”. FIG. 5 also further depicts a bottom roller positioned beneath the porous layer.

In some embodiments, one or more processes are performed on a fluid deposited on a porous layer after deposition thereon. Such process may be performed to transform the fluid, and/or one or more components thereof, into a plurality of ribs. As one example, in some embodiments, the fluid may be cured. Curing may comprise heating the fluid to promote the reaction of one or more components therein to form a solid material. The heating may comprise exposure to radiation (e.g., infrared radiation, ultraviolet radiation, gamma radiation, and/or microwave radiation). As another example, in some embodiments, the fluid may be cooled. For instance, the fluid may be cooled from a temperature at which it is deposited to a temperature at which the fluid solidifies and/or may be cooled after the performance of a curing process that occurs at an elevated temperature.

As described elsewhere herein, in some embodiments, a battery separator comprises a plurality of ribs. The ribs described herein may have a variety of chemical compositions. Further details regarding some possible chemical compositions for ribs are provided below.

In some embodiments, a plurality of ribs comprises one or more polymers. Polymers may make up a variety of suitable amounts of the ribs described herein. In some embodiments, one or more polymers make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the ribs in a plurality of ribs. In some embodiments, one or more polymers make up less than or equal to 100 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of the ribs in a plurality of ribs. Combinations of the above-referenced ranges are also possible (e.g., greater than or equal to 10 wt % and less than or equal to 100 wt %, greater than or equal to 10 wt % and less than or equal to 90 wt %, greater than or equal to 20 wt % and less than or equal to 80 wt %, or greater than or equal to 30 wt % and less than or equal to 50 wt %). Other ranges are also possible. In some embodiments, one or more polymers make up identically 100 wt % of the ribs in a plurality of ribs.

Each polymer present in a plurality of ribs may independently make up a wt % of the ribs in one or more of the above-referenced ranges. Additionally, in some embodiments, all of the polymers together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more polymers individually in an amount in one or more of the above-referenced ranges and/or may comprise a combination of polymers that are present together in an amount in one or more of the above-referenced ranges.

Non-limiting examples of suitable polymers include poly(acrylate)s, poly(ester)s, poly(alpha olefins), and poly(styrene). The polymers may comprise homopolymers and/or copolymers and/or terpolymers comprising one or more of the above types of polymers and/or monomers from one or more of the above types of polymers (e.g., poly(styrene)-poly(acrylate) copolymers). In some embodiments, the plurality of ribs comprises an amorphous polymer and/or comprises a blend of polymers that is amorphous.

When a battery separator comprises two pluralities of ribs (e.g., disposed on opposite external surfaces), each plurality of ribs may independently comprise one or more polymers having one or more of the above-described compositions.

Polymers suitable for incorporation into the ribs described herein may have a variety of suitable degrees of polymerization. In some embodiments, a polymer present in ribs in a plurality of ribs has a degree of polymerization of greater than or equal to 500, greater than or equal to 750, greater than or equal to 1000, greater than or equal to 1250, greater than or equal to 1500, greater than or equal to 1750, greater than or equal to 2000, greater than or equal to 2250, greater than or equal to 2500, greater than or equal to 2750, greater than or equal to 3000, greater than or equal to 3500, greater than or equal to 4000, greater than or equal to 4500, greater than or equal to 5000, greater than or equal to 6000, or greater than or equal to 7500. In some embodiments, a polymer present in ribs in a plurality of ribs has a degree of polymerization of less than or equal to 10000, less than or equal to 7500, less than or equal to 6000, less than or equal to 5000, less than or equal to 4500, less than or equal to 4000, less than or equal to 3500, less than or equal to 3000, less than or equal to 2750, less than or equal to 2500, less than or equal to 2250, less than or equal to 2000, less than or equal to 1750, less than or equal to 1500, less than or equal to 1250, less than or equal to 1000, or less than or equal to 750. Combinations of the above-referenced ranges are also possible (e.g., greater than or equal to 500 and less than or equal to 10000, greater than or equal to 1000 and less than or equal to 5000, or greater than or equal to 2000 and less than or equal to 3000). Other ranges are also possible.

Gel permeation chromatography may be employed to determine the degree of polymerization of a polymer present in the ribs described herein. The gel permeation chromatography may be performed on polymer that has been extracted from the ribs.

Each polymer present in a plurality of ribs may independently have a degree of polymerization in one or more of the above-referenced ranges. Additionally, in some embodiments, all of the polymers together in a plurality of ribs may have a degree of polymerization in one or more of the above-referenced ranges. When a battery separator comprises two pluralities of ribs (e.g., disposed on opposite external surfaces), each plurality of ribs may independently comprise one or more polymers individually having a degree of polymerization in one or more of the above-referenced ranges and/or may comprise a combination of polymers that together have a degree of polymerization in one or more of the above-referenced ranges.

In some embodiments, a plurality of ribs comprises one or more fillers. Fillers may make up a variety of suitable amounts of the ribs described herein. In some embodiments, one or more fillers make up greater than or equal to 0 wt %, greater than or equal to 1 wt %, greater than or equal to 2.5 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 40 wt %, greater than or equal to 50 wt %, greater than or equal to 60 wt %, greater than or equal to 70 wt %, or greater than or equal to 80 wt % of the ribs in a plurality of ribs. In some embodiments, one or more fillers make up less than or equal to 90 wt %, less than or equal to 80 wt %, less than or equal to 70 wt %, less than or equal to 60 wt %, less than or equal to 50 wt %, less than or equal to 40 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2.5 wt %, or less than or equal to 1 wt % of the ribs in a plurality of ribs. Combinations of the above-referenced ranges are also possible (e.g., greater than or equal to 0 wt % and less than or equal to 90 wt %, greater than or equal to 1 wt % and less than or equal to 30 wt %, greater than or equal to 10 wt % and less than or equal to 35 wt %, or greater than or equal to 15 wt % and less than or equal to 25 wt %). Other ranges are also possible. In some embodiments, one or more fillers make up identically 0 wt % of the ribs in a plurality of ribs.

Each filler present in a plurality of ribs may independently make up a wt % of the ribs in one or more of the above-referenced ranges. Additionally, in some embodiments, all of the fillers together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more fillers individually in an amount in one or more of the above-referenced ranges and/or may comprise a combination of fillers that are present together in an amount in one or more of the above-referenced ranges.

Fillers suitable for use in the ribs described herein may include chemically inert materials. For instance, in some embodiments, filler present in a plurality of ribs comprise a ceramic and/or glass. In some embodiments, a filler comprises a carbonate salt, silica, titanium dioxide, china clay, and/or multani mitti. Non-limiting examples of suitable carbonate salts include calcium carbonate and magnesium carbonate. Non-limiting examples of suitable types of silica include fumed silica, precipitated silica, hydrophilic silica, hydrophobic silica, mineral silica, and wollastonite silica.

When a battery separator comprises two pluralities of ribs (e.g., disposed on opposite external surfaces), each plurality of ribs may independently comprise one or more fillers having one or more of the above-described compositions.

Fillers suitable for incorporation into the ribs described herein may have a variety of suitable specific surface areas. In some embodiments, a filler present in ribs in a plurality of ribs has a specific surface area of greater than or equal to 10 m²/g, greater than or equal to 20 m²/g, greater than or equal to 50 m²/g, greater than or equal to 75 m²/g, greater than or equal to 100 m²/g, greater than or equal to 125 m²/g, greater than or equal to 150 m²/g, greater than or equal to 175 m²/g, greater than or equal to 200 m²/g, greater than or equal to 250 m²/g, greater than or equal to 300 m²/g, greater than or equal to 350 m²/g, greater than or equal to 400 m²/g, greater than or equal to 450 m²/g, greater than or equal to 500 m²/g, greater than or equal to 600 m²/g, greater than or equal to 700 m²/g, greater than or equal to 800 m²/g, greater than or equal to 950 m²/g, greater than or equal to 1250 m²/g, greater than or equal to 1500 m²/g, or greater than or equal to 1750 m²/g. In some embodiments, a filler present in ribs in a plurality of ribs has a specific surface area of less than or equal to 2000 m²/g, less than or equal to 1750 m²/g, less than or equal to 1500 m²/g, less than or equal to 1250 m²/g, less than or equal to 950 m²/g, less than or equal to 800 m²/g, less than or equal to 700 m²/g, less than or equal to 600 m²/g, less than or equal to 500 m²/g, less than or equal to 450 m²/g, less than or equal to 400 m²/g, less than or equal to 350 m²/g, less than or equal to 300 m²/g, less than or equal to 250 m²/g, less than or equal to 200 m²/g, less than or equal to 175 m²/g, less than or equal to 150 m²/g, less than or equal to 125 m²/g, less than or equal to 100 m²/g, less than or equal to 75 m²/g, less than or equal to 50 m²/g, or less than or equal to 20 m²/g. Combinations of the above-referenced ranges are also possible (e.g., greater than or equal to 10 m²/g and less than or equal to 2000 m²/g, greater than or equal to 20 m²/g and less than or equal to 950 m²/g, greater than or equal to 100 m²/g and less than or equal to 500 m²/g, or greater than or equal to 150 m²/g and less than or equal to 300 m²/g). Other ranges are also possible.

The specific surface area may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 100° C. for a minimum of 3 hours.

Each filler present in a plurality of ribs may independently have a specific surface area in one or more of the above-referenced ranges. Additionally, in some embodiments, all of the fillers together in a plurality of ribs may have a specific surface area in one or more of the above-referenced ranges. When a battery separator comprises two pluralities of ribs (e.g., disposed on opposite external surfaces), each plurality of ribs may independently comprise one or more fillers individually having a specific surface area in one or more of the above-referenced ranges and/or may comprise a combination of fillers that together have a specific surface area in one or more of the above-referenced ranges.

Fillers suitable for incorporation into the ribs described herein may have a variety of suitable specific pore volumes. In some embodiments, a filler present in ribs in a plurality of ribs has a specific pore volume of greater than or equal to 0.2 cm³/g, greater than or equal to 0.3 cm³/g, greater than or equal to 0.4 cm³/g, greater than or equal to 0.5 cm³/g, greater than or equal to 0.6 cm³/g, greater than or equal to 0.8 cm³/g, greater than or equal to 1 cm³/g, greater than or equal to 1.25 cm³/g, greater than or equal to 1.5 cm³/g, greater than or equal to 1.75 cm³/g, greater than or equal to 2 cm³/g, greater than or equal to 2.25 cm³/g, greater than or equal to 2.5 cm³/g, or greater than or equal to 2.75 cm³/g. In some embodiments, a filler present in ribs in a plurality of ribs has a specific pore volume of less than or equal to 3 cm³/g, less than or equal to 2.75 cm³/g, less than or equal to 2.5 cm³/g, less than or equal to 2.25 cm³/g, less than or equal to 2 cm³/g, less than or equal to 1.75 cm³/g, less than or equal to 1.5 cm³/g, less than or equal to 1.25 cm³/g, less than or equal to 1 cm³/g, less than or equal to 0.8 cm³/g, less than or equal to 0.6 cm³/g, less than or equal to 0.5 cm³/g, less than or equal to 0.4 cm³/g, or less than or equal to 0.3 cm³/g. Combinations of the above-referenced ranges are also possible (e.g., greater than or equal to 0.2 cm³/g and less than or equal to 3 cm³/g, greater than or equal to 0.5 cm³/g and less than or equal to 2 cm³/g, or greater than or equal to 1 cm³/g and less than or equal to 1.5 cm³/g). Other ranges are also possible.

The specific pore volume of a filler may be determined in accordance with ASTM F316-03 (2019).

Each filler present in a plurality of ribs may independently have a specific pore volume in one or more of the above-referenced ranges. Additionally, in some embodiments, all of the fillers together in a plurality of ribs may have a specific pore volume in one or more of the above-referenced ranges. When a battery separator comprises two pluralities of ribs (e.g., disposed on opposite external surfaces), each plurality of ribs may independently comprise one or more fillers individually having a specific pore volume in one or more of the above-referenced ranges and/or may comprise a combination of fillers that together have a specific pore volume in one or more of the above-referenced ranges.

Fillers suitable for incorporation into the ribs described herein may have a variety of suitable average diameters. In some embodiments, a filler present in ribs in a plurality of ribs has an average diameter of greater than or equal to 0.01 micron, greater than or equal to 0.02 microns, greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 4 microns, greater than or equal to 5 microns, greater than or equal to 7.5 microns, greater than or equal to 10 microns, greater than or equal to 12 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 50 microns, or greater than or equal to 60 microns. In some embodiments, a filler present in ribs in a plurality of ribs has an average diameter of less than or equal to 75 microns, less than or equal to 60 microns, less than or equal to 50 microns, less than or equal to 40 microns, less than or equal to 35 microns, less than or equal to 30 microns, less than or equal to 25 microns, less than or equal to 20 microns, less than or equal to 15 microns, less than or equal to 12 microns, less than or equal to 10 microns, less than or equal to 7.5 microns, less than or equal to 5 microns, less than or equal to 4 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.075 microns, less than or equal to 0.05 microns, or less than or equal to 0.02 microns. Combinations of the above-referenced ranges are also possible (e.g., greater than or equal to 0.01 micron and less than or equal to 75 microns, greater than or equal to 1 micron and less than or equal to 60 microns, greater than or equal to 4 microns and less than or equal to 12 microns, or greater than or equal to 10 microns and less than or equal to 30 microns). Other ranges are also possible.

Each filler present in a plurality of ribs may independently have an average diameter in one or more of the above-referenced ranges. Additionally, in some embodiments, all of the fillers together in a plurality of ribs may have an average diameter in one or more of the above-referenced ranges. When a battery separator comprises two pluralities of ribs (e.g., disposed on opposite external surfaces), each plurality of ribs may independently comprise one or more fillers individually having an average diameter in one or more of the above-referenced ranges and/or may comprise a combination of fillers that together have an average diameter in one or more of the above-referenced ranges.

In some embodiments, a plurality of ribs comprises one or more plasticizers. When present, such plasticizers may be covalently-bonded to one or more other species also present in the ribs (e.g., to one or more polymers therein) or lack such covalent bonds. Plasticizers may make up a variety of suitable amounts of the ribs described herein. In some embodiments, one or more plasticizers make up greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of the ribs in a plurality of ribs. In some embodiments, one or more plasticizers make up less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, or less than or equal to 15 wt % of the ribs in a plurality of ribs. Combinations of the above-referenced ranges are also possible (e.g., greater than or equal to 10 wt % and less than or equal to 60 wt %, greater than or equal to 20 wt % and less than or equal to 50 wt %, or greater than or equal to 30 wt % and less than or equal to 40 wt %). Other ranges are also possible.

Each plasticizer present in a plurality of ribs may independently make up a wt % of the ribs in one or more of the above-referenced ranges. Additionally, in some embodiments, all of the plasticizers together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more plasticizers individually in an amount in one or more of the above-referenced ranges and/or may comprise a combination of plasticizers that are present together in an amount in one or more of the above-referenced ranges.

Non-limiting examples of suitable plasticizers include non-volatile organic compounds, sulfates of alkylsulfite acids, esters of alkylsulfite acids, alcohols, phenols, diesters of ortho-phthalic acids, epoxy esters of unsaturated fatty acids (e.g., plant-derived epoxy esters of unsaturated fatty acids, epoxidized butyl esters of unsaturated fatty acids, epoxidized n-hexyl esters of unsaturated fatty acids), reaction products of phthalic anhydrides, reaction products of oxo alcohols (e.g., comprising greater than or equal to 4 and less than or equal to 13 carbon atoms).

When a battery separator comprises two pluralities of ribs (e.g., disposed on opposite external surfaces), each plurality of ribs may independently comprise one or more plasticizers having one or more of the above-described compositions.

In some embodiments, ribs in a plurality of ribs comprise relatively low (or zero) amounts of species that may leach deleteriously therefrom upon exposure to one or more oxidative fluids for one or more periods of time. Non-limiting examples of such species include leachable plasticizers. Three non-limiting examples of oxidative fluids into which relatively low (or zero) amounts of species may leach are: (1) sulfuric acid having a specific gravity of 1.260, (2) sulfuric acid having a specific gravity of 1.260 comprising potassium dichromate; and (3) sulfuric acid having a specific gravity of 1.260 comprising hydrogen peroxide. Two non-limiting examples of time periods over which the relatively low (or zero) amounts of species may leach are: (1) 3 hours; and (2) 24 hours.

The amount of species that leach from the ribs upon exposure to an oxidative fluid in a plurality of ribs may be determined by exposing the plurality of ribs to the relevant oxidative fluid and then measuring the amount of weight loss during this process. The amount of weight lost is taken to be equivalent to the amount of leachable species initially present. For the amount of species that leaches from the ribs over 3 hours, these measurements may be made in accordance with BCIS-03B-23, BCIS-03B-24, and BCIS-03B-22 (2015) for the oxidative fluids of sulfuric acid having a specific gravity of 1.260, sulfuric acid having a specific gravity of 1.260 comprising potassium dichromate, and sulfuric acid having a specific gravity of 1.260 further comprising hydrogen peroxide, respectively. For the amount of species that leaches from the ribs over 24 hours, these measurements may be made in accordance with the same testing standards described in the preceding sentence modified such that the exposure to the oxidative fluid occurs for 24 hours instead of 3 hours.

Species that leach from the ribs upon exposure to an oxidative fluid may make up less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, or less than or equal to 0.1 wt % of the ribs. Species that leach from the ribs upon exposure to an oxidative fluid may make up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 3.5 wt %, greater than or equal to 4 wt %, or greater than or equal to 4.5 wt % of the ribs. Combinations of the above-referenced ranges are also possible (e.g., less than or equal to 5 wt % and greater than or equal to 0 wt %, less than or equal to 2 wt % and greater than or equal to 0 wt %, or less than or equal to 1 wt % and greater than or equal to 0 wt %). Other ranges are also possible. In some embodiments, species that leach from the ribs upon exposure to sulfuric acid having a specific gravity of 1.260 make up identically 0 wt % of the ribs.

A battery separator may comprise an amount of species that leach from the ribs in one or more of the above-referenced ranges as measured under one or more of the following conditions: (1) exposure to sulfuric acid having a specific gravity of 1.260 for 3 hours; (2) exposure to sulfuric acid having a specific gravity of 1.260 comprising potassium dichromate for 3 hours; (3) exposure to sulfuric acid having a specific gravity of 1.260 comprising hydrogen peroxide for 3 hours; (4) exposure to acid having a specific gravity of 1.260 for 24 hours; (5) exposure to sulfuric acid having a specific gravity of 1.260 comprising potassium dichromate for 24 hours; and (6) exposure to sulfuric acid having a specific gravity of 1.260 comprising hydrogen peroxide for 24 hours.

When a battery separator comprises two pluralities of ribs (e.g., disposed on opposite external surfaces), each plurality of ribs may independently be described by one or more of the conditions in the preceding paragraph and/or both pluralities of ribs may together comprise an amount of species that are described by one or more of the conditions in the preceding paragraph.

In some embodiments, a relatively low amount of iron ions may be leached from a plurality of ribs upon exposure to a volume of 98% sulfuric acid. The amount of iron ions leached from the plurality of ribs may be less than or equal to 100 ppm, less than or equal to 90 ppm, less than or equal to 80 ppm, less than or equal to 70 ppm, less than or equal to 60 ppm, less than or equal to 55 ppm, less than or equal to 50 ppm, less than or equal to 45 ppm, less than or equal to 40 ppm, less than or equal to 35 ppm, less than or equal to 30 ppm, less than or equal to 25 ppm, less than or equal to 20 ppm less than or equal to 15 ppm, less than or equal to 10 ppm, or less than or equal to 5 ppm. The amount of iron ions leached from the plurality of ribs may be greater than or equal to 0 ppm, greater than or equal to 5 ppm, greater than or equal to 10 ppm, greater than or equal to 15 ppm, greater than or equal to 20 ppm, greater than or equal to 25 ppm, greater than or equal to 30 ppm, greater than or equal to 35 ppm, greater than or equal to 40 ppm, greater than or equal to 45 ppm, greater than or equal to 50 ppm, greater than or equal to 55 ppm, greater than or equal to 60 ppm, greater than or equal to 70 ppm, greater than or equal to 80 ppm, or greater than or equal to 90 ppm. Combinations of the above-referenced ranges are also possible (e.g., less than or equal to 100 ppm and greater than or equal to 0 ppm, less than or equal to 60 ppm and greater than or equal to 0 ppm, less than or equal to 30 ppm and greater than or equal to 0 ppm, or less than or equal to 25 ppm and greater than or equal to 0 ppm). Other ranges also apply. In some embodiments, identically 0 ppm of iron ions leaches from the plurality of ribs upon exposure to 98% sulfuric acid.

The leaching of iron ions from ribs upon exposure to 98% sulfuric acid may be determined in accordance with IS 6071 (1986).

When a battery separator comprises two pluralities of ribs (e.g., disposed on opposite external surfaces), each plurality of ribs may independently leach an amount of iron ions therefrom upon exposure to 98% sulfuric acid in one or more of the above-referenced ranges and/or both pluralities of ribs may together leach an amount of iron ions therefrom upon exposure to 98% sulfuric acid in one or more of the above-referenced ranges.

In some embodiments, a relatively low amount of chloride ions may be leached from a plurality of ribs upon exposure to a volume of 98% sulfuric acid. The amount of chloride ions leached from the plurality of ribs may be less than or equal to 100 ppm, less than or equal to 80 ppm, less than or equal to 60 ppm, less than or equal to 50 ppm, less than or equal to 40 ppm, less than or equal to 30 ppm, less than or equal to 25 ppm, less than or equal to 20 ppm less than or equal to 15 ppm, less than or equal to 10 ppm, or less than or equal to 5 ppm. The amount of chloride ions leached from the plurality of ribs may be greater than or equal to 0 ppm, greater than or equal to 5 ppm, greater than or equal to 10 ppm, greater than or equal to 15 ppm, greater than or equal to 20 ppm, greater than or equal to 25 ppm, greater than or equal to 30 ppm, greater than or equal to 40 ppm, greater than or equal to 50 ppm, greater than or equal to 60 ppm, or greater than or equal to 80 ppm. Combinations of the above-referenced ranges are also possible (e.g., less than or equal to 100 ppm and greater than or equal to 0 ppm, less than or equal to 30 ppm and greater than or equal to 0 ppm, less than or equal to 20 ppm and greater than or equal to 0 ppm, or less than or equal to 10 ppm and greater than or equal to 0 ppm). Other ranges also apply. In some embodiments, identically 0 ppm of chloride ions leaches from the plurality of ribs upon exposure to 98% sulfuric acid.

The leaching of chloride ions from ribs upon exposure to 98% sulfuric acid may be determined in accordance with BCIS-03A (2015).

When a battery separator comprises two pluralities of ribs (e.g., disposed on opposite external surfaces), each plurality of ribs may independently leach an amount of chloride ions therefrom upon exposure to 98% sulfuric acid in one or more of the above-referenced ranges and/or both pluralities of ribs may together leach an amount of chloride ions therefrom upon exposure to 98% sulfuric acid in one or more of the above-referenced ranges.

In some embodiments, ribs in a plurality of ribs are formed from a fluid comprising one or more species that are described above (e.g., one or more polymers, one or more fillers, one or more plasticizers). Such species may be present in the fluid in one or more of the ranges described above with respect to the amount that these species may make up of ribs in a plurality of ribs. In some embodiments, one or more such species may be present in the form of particulates dispersed and/or suspended in the fluid (e.g., polymer particles, filler particles, plasticizer particles). Such particles may be uniformly or non-uniformly dispersed through the fluid.

It is also possible for the fluid to comprise one or more species that are removed from the fluid during rib formation. For instance, the fluid may comprise a species that evaporates, outgasses, and/or undergoes a chemical reaction (e.g., a chemical reaction resulting in outgassing) during rib formation. This species may be removed upon deposition of the fluid onto a porous layer and/or during one or more subsequent steps (e.g., during a curing step). One example of a species having this property is a solvent, such as an aqueous solvent. Another example of a species having this property is a pore-forming additive. The pore-forming additive may undergo a reaction to produce a gas and/or outgas during a curing process performed after a fluid to be transformed into a plurality of ribs is deposited on a porous layer. During the reaction and/or outgassing, the pore-forming additive may expand greatly in size. This expansion may push apart the fluid and/or a reaction product of the fluid forming during the curing process, leaving behind a plurality of pores in the resultant ribs.

Pore-forming additives may be present in a variety of amounts in fluids from which ribs are formed. In some embodiments, one or more pore-forming additives make up greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, or greater than or equal to 25 wt % of a fluid from which a plurality of ribs is formed. In some embodiments, one or more pore-forming additives make up less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, less than or equal to 0.1 wt %, or less than or equal to 0.075 wt % of a fluid from which a plurality of ribs is formed. Combinations of the above-referenced ranges are also possible (e.g., greater than or equal to 0.05 wt % and less than or equal to 30 wt %, greater than or equal to 0.05 wt % and less than or equal to 20 wt %, greater than or equal to 0.5 wt % and less than or equal to 10 wt %, or greater than or equal to 1 wt % and less than or equal to 5 wt %). Other ranges are also possible.

Each pore-forming additive present in a fluid from which a plurality of ribs is formed may independently make up a wt % of the fluid in one or more of the above-referenced ranges. Additionally, in some embodiments, all of the pore-forming additives together in a fluid from which a plurality of ribs is formed may make up a wt % of the fluid in one or more of the above-referenced ranges. When a battery separator comprises two pluralities of ribs (e.g., disposed on opposite external surfaces), each fluid from which a plurality of ribs is formed may independently comprise one or more pore-forming additives individually in an amount in one or more of the above-referenced ranges and/or may comprise a combination of pore-forming additives that are present together in an amount in one or more of the above-referenced ranges.

Pore-forming additives suitable for use in the fluids from which ribs may be formed may include a variety of suitable materials, non-limiting examples of which include azodicarbonamide, microspheres comprising a polymeric shell, dinitrosopentamethylenetetramine, 4-methylbenzenesulfohydrazide, 4-toluene sulfohydrazide, p,p-oxybisbenzenesulfonylhydrazide. Polymer(s) present in a pore-forming additive and/or a polymeric shell of a microsphere may comprise homopolymers and/or copolymers. In some embodiments, pore-forming additive and/or a polymeric shell of a microsphere comprises repeat units that are polymerized ethylenically unsaturated species. Such species may include nitrile-containing monomers (e.g., acrylonitrile, methacrylonitrile, α-chloroacrylonitrile, α-ethoxyacrylonitrile, fumaronitrile, crotonitrile), acrylic esters (e.g., methyl acrylate, ethyl acrylate), methacrylic esters (e.g., methyl methacrylate, isobornyl methacrylate, ethyl methacrylate, hydroxyethylmethacrylate), vinyl halides (e.g., vinyl chloride, vinylidene chloride) vinyl pyridine, vinyl esters (e.g., vinyl acetate), styrenes (e.g., styrene, halogenated styrenes, α-methyl styrene), dienes (e.g., butadiene, isoprene, chloroprene), unsaturated carboxylic compounds (e.g., acrylic acid, methacrylic acid, salts thereof), acrylamide, and/or N-substituted maleimides. Additionally, one non-limiting example of a suitable microsphere comprising a polymeric shell is expancel.

When a battery separator comprises two pluralities of ribs (e.g., disposed on opposite external surfaces), each plurality of ribs may independently be formed from a fluid comprising one or more pore-forming additives having one or more of the above-described compositions.

In some embodiments, pore-forming additives suitable for incorporation into the fluids from which ribs may be formed described herein may be particulate. In such embodiments, the particles may have a variety of suitable average diameters. In some embodiments, one or more pore-forming additives has an average diameter of greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, or greater than or equal to 40 microns. In some embodiments, one or more pore-forming additives has an average diameter of less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.75 microns, less than or equal to 0.5 microns, less than or equal to 0.2 microns, less than or equal to 0.1 micron, or less than or equal to 0.075 microns. Combinations of the above-referenced ranges are also possible (e.g., greater than or equal to 0.05 microns and less than or equal to 50 microns, greater than or equal to 0.05 microns and less than or equal to 20 microns, greater than or equal to 0.5 microns and less than or equal to 10 microns, or greater than or equal to 1 micron and less than or equal to 5 microns). Other ranges are also possible.

As used herein, the average diameter of a plurality of particles is the average of the diameters of the particles in the plurality of particles. The diameter of each particle in a plurality of particles is equivalent to the largest cross-sectional diameter of the particle.

Each pore-forming additive present in a fluid from which a plurality of ribs is formed may independently have an average diameter in one or more of the above-referenced ranges. Additionally, in some embodiments, all of the pore-forming additives together in a fluid from which a plurality of ribs is formed may have an average diameter in one or more of the above-referenced ranges. When a battery separator comprises two pluralities of ribs (e.g., disposed on opposite external surfaces), each fluid from which a plurality of ribs is formed may independently comprise one or more pore-forming additives individually having an average diameter in one or more of the above-referenced ranges and/or may comprise a combination of pore-forming additives that together have an average diameter in one or more of the above-referenced ranges.

The ribs described herein may have a variety of suitable morphologies and physical properties. Further details regarding such properties are provided below.

Pluralities of ribs may cover a variety of suitable percentages of a surface of a porous layer on which they are disposed. In some embodiments, a plurality of ribs covers greater than or equal to 0.05%, greater than or equal to 0.075%, greater than or equal to 0.1%, greater than or equal to 0.2%, greater than or equal to 0.5%, greater than or equal to 0.75%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 17.5%, greater than or equal to 20%, greater than or equal to 22.5%, greater than or equal to 25%, greater than or equal to 27.5%, greater than or equal to 30%, greater than or equal to 32.5%, greater than or equal to 35%, or greater than or equal to 37.5% of a surface of a porous layer on which it is disposed. In some embodiments, a plurality of ribs covers less than or equal to 40%, less than or equal to 37.5%, less than or equal to 35%, less than or equal to 32.5%, less than or equal to 30%, less than or equal to 27.5%, less than or equal to 25%, less than or equal to 22.5%, less than or equal to 20%, less than or equal to 17.5%, less than or equal to 15%, less than or equal to 12.5%, less than or equal to 10%, less than or equal to 7.5%, less than or equal to 5%, less than or equal to 2%, less than or equal to 1%, less than or equal to 0.75%, less than or equal to 0.5%, less than or equal to 0.2%, less than or equal to 0.1%, or less than or equal to 0.075% of a surface of a porous layer on which it is disposed. Combinations of the above-referenced ranges are also possible (e.g., greater than or equal to 0.05% and less than or equal to 40%, greater than or equal to 10% and less than or equal to 15%, or greater than or equal to 20% and less than or equal to 30%). Other ranges are also possible.

The ranges described above may refer to the percentage of the surface area of the porous layer on which the ribs are disposed that is in direct contact with the ribs. Additionally, when a battery separator comprises two pluralities of ribs (e.g., disposed on opposite external surfaces), each plurality of ribs may independently cover a percentage of a porous layer on which it is disposed in one or more of the above-referenced ranges.

Pluralities of ribs may have a variety of suitable average heights. In some embodiments, the average height of the ribs in a plurality of ribs is greater than or equal to 0.05 mm, greater than or equal to 0.075 mm, greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.75 mm, greater than or equal to 1 mm, greater than or equal to 1.25 mm, greater than or equal to 1.5 mm, greater than or equal to 1.75 mm, greater than or equal to 2 mm, greater than or equal to 2.25 mm, greater than or equal to 2.5 mm, or greater than or equal to 2.75 mm. In some embodiments, the average height of the ribs in a plurality of ribs is less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 0.75 mm, less than or equal to 0.6 mm, less than or equal to 0.5 mm, less than or equal to 0.4 mm, less than or equal to 0.3 mm, less than or equal to 0.2 mm, less than or equal to 0.1 mm, or less than or equal to 0.075 mm. Combinations of the above-referenced ranges are also possible (e.g., greater than or equal to 0.05 mm and less than or equal to 3 mm, greater than or equal to 0.5 mm and less than or equal to 2 mm, or greater than or equal to 0.6 mm and less than or equal to 1 mm). Other ranges are also possible.

When a battery separator comprises two pluralities of ribs (e.g., disposed on opposite external surfaces), each plurality of ribs may independently comprise ribs having an average height in one or more of the above-referenced ranges.

Pluralities of ribs may have a variety of suitable average widths. The average width of the ribs in a plurality of ribs may be an average of the widths of the ribs therein. In some embodiments, the average width of the ribs in a plurality of ribs is greater than or equal to 0.05 mm, greater than or equal to 0.075 mm, greater than or equal to 0.1 mm, greater than or equal to 0.2 mm, greater than or equal to 0.5 mm, greater than or equal to 1 mm, greater than or equal to 1.25 mm, greater than or equal to 1.5 mm, greater than or equal to 1.75 mm, greater than or equal to 2 mm, greater than or equal to 2.25 mm, greater than or equal to 2.5 mm, greater than or equal to 2.75 mm, greater than or equal to 3 mm, greater than or equal to 3.5 mm, greater than or equal to 4 mm, or greater than or equal to 4.5 mm. In some embodiments, the average width of the ribs in a plurality of ribs is less than or equal to 5 mm, less than or equal to 4.5 mm, less than or equal to 4 mm, less than or equal to 3.5 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 0.75 mm, less than or equal to 0.5 mm, less than or equal to 0.2 mm, less than or equal to 0.1 mm, or less than or equal to 0.075 mm. Combinations of the above-referenced ranges are also possible (e.g., greater than or equal to 0.05 mm and less than or equal to 5 mm, greater than or equal to 0.05 mm and less than or equal to 2.5 mm, greater than or equal to 0.5 mm and less than or equal to 5 mm, greater than or equal to 1 mm and less than or equal to 5 mm, greater than or equal to 1.5 mm and less than or equal to 3 mm, or greater than or equal to 2 mm and less than or equal to 2.5 mm). Other ranges are also possible.

When a battery separator comprises two pluralities of ribs (e.g., disposed on opposite external surfaces), each plurality of ribs may independently comprise ribs having an average width in one or more of the above-referenced ranges. The external ribs configured to face the negative battery plate may have a smaller average width than the ribs configured to face the positive battery plate. In some embodiments, ribs configured to face the negative battery plate have an average width of greater than or equal to 0.05 mm and less than or equal to 2.5 mm. In some embodiments, ribs configured to face the positive battery plate have an average width of greater than or equal to 0.5 mm and less than or equal to 2.5 mm.

Pluralities of ribs may have a variety of suitable average aspect ratios. The aspect ratio of a rib may be equivalent to the ratio of its length to its width. The average aspect ratios of the ribs in a plurality of ribs may be an average of the aspect ratios of the ribs therein. In some embodiments, the average aspect ratio of the ribs in a plurality of ribs is greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, greater than or equal to 12.5, greater than or equal to 15, greater than or equal to 17.5, greater than or equal to 20, greater than or equal to 25, greater than or equal to 30, or greater than or equal to 35. In some embodiments, the average aspect ratio of the ribs in a plurality of ribs is less than or equal to 40, less than or equal to 35, less than or equal to 30, less than or equal to 25, less than or equal to 20, less than or equal to 17.5, less than or equal to 15, less than or equal to 12.5, less than or equal to 10, less than or equal to 9, less than or equal to 8, less than or equal to 7, less than or equal to 6, less than or equal to 5, less than or equal to 4, less than or equal to 3, or less than or equal to 2. Combinations of the above-referenced ranges are also possible (e.g., greater than or equal to 1 and less than or equal to 40, greater than or equal to 5 and less than or equal to 8, or greater than or equal to 10 and less than or equal to 20). Other ranges are also possible. In some embodiments, the average aspect ratio of the ribs in a plurality of ribs is identically 1 (e.g., when the ribs are dots or squares).

When a battery separator comprises two pluralities of ribs (e.g., disposed on opposite external surfaces), each plurality of ribs may independently comprise ribs having an average aspect ratio in one or more of the above-referenced ranges.

Pluralities of ribs may have a variety of suitable average spacings. In some embodiments, a plurality of ribs comprises ribs having an average spacing of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, or greater than or equal to 22.5 mm. In some embodiments, a plurality of ribs comprises ribs having an average spacing of less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 25 mm, greater than or equal to 0.1 mm and less than or equal to 12.5 mm, or greater than or equal to 2 mm and less than or equal to 25 mm). Other ranges are also possible.

When a battery separator comprises two pluralities of ribs (e.g., disposed on opposite external surfaces), each plurality of ribs may independently comprise ribs having an average spacing in one or more of the above-referenced ranges.

In some embodiments, it may be advantageous for a battery separator to comprise two pluralities of ribs on opposite external surfaces having different average spacings. The external ribs configured to face the negative battery plate may have a smaller average spacing than the ribs configured to face the positive battery plate. In some embodiments, ribs configured to face the negative battery plate have an average spacing of greater than or equal to 0.1 mm and less than or equal to 12.5 mm. In some embodiments, ribs configured to face the positive battery plate have an average spacing of greater than or equal to 2 mm and less than or equal to 25 mm.

Pluralities of ribs may have a variety of suitable frequencies. In some embodiments, a plurality of ribs comprises ribs having a frequency in the machine direction of greater than or equal to 20 ribs/m, greater than or equal to 30 ribs/m, greater than or equal to 40 ribs/m, greater than or equal to 50 ribs/m, greater than or equal to 60 ribs/m, greater than or equal to 70 ribs/m, greater than or equal to 80 ribs/m, greater than or equal to 90 ribs/m, greater than or equal to 100 ribs/m, greater than or equal to 125 ribs/m, greater than or equal to 150 ribs/m, greater than or equal to 175 ribs/m, greater than or equal to 200 ribs/m, greater than or equal to 250 ribs/m, greater than or equal to 300 ribs/m, greater than or equal to 400 ribs/m, greater than or equal to 500 ribs/m, or greater than or equal to 750 ribs/m. In some embodiments, a plurality of ribs comprises ribs having a frequency in the machine direction of less than or equal to 1000 ribs/m, less than or equal to 750 ribs/m, less than or equal to 500 ribs/m, less than or equal to 400 ribs/m, less than or equal to 300 ribs/m, less than or equal to 250 ribs/m, less than or equal to 200 ribs/m, less than or equal to 175 ribs/m, less than or equal to 150 ribs/m, less than or equal to 125 ribs/m, less than or equal to 100 ribs/m, less than or equal to 90 ribs/m, less than or equal to 80 ribs/m, less than or equal to 70 ribs/m, less than or equal to 60 ribs/m, less than or equal to 50 ribs/m, less than or equal to 40 ribs/m, or less than or equal to 30 ribs/m. Combinations of the above-referenced ranges are also possible (e.g., greater than or equal to 20 ribs/m and less than or equal to 1000 ribs/m, greater than or equal to 50 ribs/m and less than or equal to 500 ribs/m, or greater than or equal to 80 ribs/m and less than or equal to 250 ribs/m). Other ranges are also possible.

When a battery separator comprises two pluralities of ribs (e.g., disposed on opposite external surfaces), each plurality of ribs may independently comprise ribs having a frequency in one or more of the above-referenced ranges.

Pluralities of ribs may be oriented in a variety of suitable manners. In some embodiments, an average angle of the direction of the length of the rib to the machine direction may be greater than or equal to 0°, greater than or equal to 5°, greater than or equal to 10°, greater than or equal to 15°, greater than or equal to 20°, greater than or equal to 25°, greater than or equal to 30°, greater than or equal to 35°, greater than or equal to 40°, greater than or equal to 45°, greater than or equal to 50°, greater than or equal to 55°, greater than or equal to 60°, greater than or equal to 65°, greater than or equal to 70°, greater than or equal to 75°, greater than or equal to 80°, or greater than or equal to 85°. In some embodiments, an average angle of the direction of the length of the rib to the machine direction may be less than or equal to 90°, less than or equal to 85°, less than or equal to 80°, less than or equal to 75°, less than or equal to 70°, less than or equal to 65°, less than or equal to 60°, less than or equal to 55°, less than or equal to 50°, less than or equal to 45°, less than or equal to 40°, less than or equal to 35°, less than or equal to 30°, less than or equal to 25°, less than or equal to 20°, less than or equal to 15°, less than or equal to 10°, or less than or equal to 5°. Combinations of the above-referenced ranges are also possible (e.g., greater than or equal to 0° and less than or equal to 90°, greater than or equal to 0° and less than or equal to 45°, or greater than or equal to 0° and less than or equal to 15°). Other ranges are also possible. In some embodiments, the average angle of the direction of the length of the ribs to the machine direction is identically 0°. In some embodiments, the average angle of the direction of the length of the ribs to the machine direction is identically 90°.

When a battery separator comprises two pluralities of ribs (e.g., disposed on opposite external surfaces), each plurality of ribs may independently comprise ribs having an average angle to the machine direction in one or more of the above-referenced ranges.

Pluralities of ribs may have a variety of average porosities. In some embodiments, an average porosity of the ribs in a plurality of ribs is greater than or equal to 0%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, or greater than or equal to 85%. In some embodiments, the average porosity of the ribs in a plurality of ribs less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 20%, less than or equal to 15%, less than or equal to 10%, or less than or equal to 5%. Combinations of the above-referenced ranges are also possible (e.g., greater than or equal to 0% and less than or equal to 90%, greater than or equal to 20% and less than or equal to 80%, or greater than or equal to 30% and less than or equal to 70%). Other ranges are also possible. In some embodiments, the average porosity of the ribs in a plurality of ribs is identically 0%.

The average porosity of the ribs in a plurality of ribs may be determined by: (1) measuring the average porosity of a porous layer on which ribs are disposed and the ribs together in accordance with BCIS-03B (2015); (2) measuring the average porosity of the porous layer alone in accordance with BCIS-03B (2015); and (3) computing the average porosity of the ribs based on these two measurements.

When a battery separator comprises two pluralities of ribs (e.g., disposed on opposite external surfaces), each plurality of ribs may independently comprise ribs having an average porosity in one or more of the above-referenced ranges.

In some embodiments, ribs in a plurality of ribs are relatively thermally stable. In some embodiments, ribs in a plurality of ribs may exhibit relatively low amounts of mass loss upon exposure to heat. The ribs in the plurality of ribs may lose less than or equal to 5%, less than or equal to 4.5%, less than or equal to 4%, less than or equal to 3.5%, less than or equal to 3%, less than or equal to 2.5%, less than or equal to 2%, less than or equal to 1.5%, less than or equal to 1%, less than or equal to 0.75%, less than or equal to 0.5%, less than or equal to 0.2%, or less than or equal to 0.1% of their mass upon exposure to a temperature of 160° C. for 13 minutes. The ribs in the plurality of ribs may lose greater than or equal to 0%, greater than or equal to 0.1%, greater than or equal to 0.2%, greater than or equal to 0.5%, greater than or equal to 0.75%, greater than or equal to 1%, greater than or equal to 1.5%, greater than or equal to 2%, greater than or equal to 2.5%, greater than or equal to 3%, greater than or equal to 3.5%, greater than or equal to 4%, or greater than or equal to 4.5% of their mass upon exposure to a temperature of 160° C. for 13 minutes. Combinations of the above-referenced ranges are also possible (e.g., less than or equal to 5% and greater than or equal to 0%, less than or equal to 4% and greater than or equal to 0%, less than or equal to 2% and greater than or equal to 0%, or less than or equal to 1% and greater than or equal to 0%). Other ranges are also possible. In some embodiments, the ribs in a plurality of ribs lose identically 0% of their mass upon exposure to a temperature of 160° C. for 13 minutes.

The exposure of the plurality of ribs to the temperature of 160° C. for 13 minutes and the measurement of any associated mass loss may be determined by heating a sample of the plurality of ribs in a thermogravimetric analyzer to 160° C., holding it at 160° C. therein, and employing the thermogravimetric analyzer to measure the mass loss.

When a battery separator comprises two pluralities of ribs (e.g., disposed on opposite external surfaces), each plurality of ribs may independently comprise ribs having a thermal stability in one or more of the above-referenced ranges.

As described elsewhere herein, in some embodiments, a battery separator comprises a porous layer. A variety of suitable types of porous layers may be employed, some of which may be fibrous and some of which may be non-fibrous. For instance, some battery separators may comprise one or more of the following types of porous layers: non-woven fiber webs (e.g., wet laid non-woven fiber webs, non-wet laid non-woven fiber webs), membranes (e.g., extruded membranes, sintered membranes, cast membranes), woven layers, knitted layers, and braided layers. Additionally, although it should be noted that non-fibrous porous layers may have any of the properties described elsewhere herein with respect to porous layers, some exemplary non-fibrous porous layers include membranes having a porosity of greater than or equal to 30% and less than or equal to 70% and a mean flow pore size of greater than or equal to 0.05 microns and less than or equal to 1 micron, sintered membranes having a porosity of greater than or equal to 25% and less than or equal to 60% and a mean flow pore size of greater than or equal to 2.5 microns and less than or equal to 75 microns, and cast membranes having a porosity of greater than or equal to 25% and less than or equal to 50% and a mean flow pore size of greater than or equal to 0.05 microns and less than or equal to 1 micron.

Battery separators that comprise two or more porous layers may comprise two or more porous layers of the same type and/or may comprise two or more porous layers of different types. Porous layers of different types may have similar properties and porous layers of the same type may have different properties. Accordingly, references herein to porous layers should be understood to refer to porous layers of any suitable type of porous layer and references to porous layer properties should be understood to refer to the properties of any suitable type of porous layer unless otherwise specified.

Additionally, porous layers within a battery separator comprising two or more porous layers may be arranged as desired. For instance, a battery separator may comprise any of the above-described porous layers in one or more of the following positions: an outermost layer in the battery separator (e.g., in a battery separator for which a plurality of ribs does not form one of the outermost layers), a layer directly adjacent to a plurality of ribs, and a layer that is both not an outermost layer and not directly adjacent to a plurality of ribs.

Layers and battery separator components disposed on each other as described herein and/or shown in the figures herein may be directly disposed on each other or may be indirectly disposed on each other. In other words, as used herein, when a layer and/or component is referred to as being “disposed on” or “adjacent” another layer and/or component, it can be directly disposed on or adjacent the layer and/or component, or it may be disposed on one or more intervening layers and/or components disposed on the other layer and/or component. A layer and/or component that is “directly disposed on”, “directly adjacent” or “in contact with” another layer and/or component means that it is disposed on the other layer and/or component in a manner such that no intervening layer and/or component is present.

In some embodiments, a porous layer is fibrous. Fibers in a porous fibrous layer may have a variety of suitable average fiber diameters. In some embodiments, fibers in a porous fibrous layer have an average fiber diameter of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, or greater than or equal to 15 microns. In some embodiments, fibers in a porous fibrous layer have an average fiber diameter of less than or equal to 20 microns, less than or equal to 15 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 20 microns, greater than or equal to 0.5 microns and less than or equal to 5 microns, or greater than or equal to 0.5 microns and less than or equal to 2 microns). Other ranges are also possible.

Each type of fiber present in a fibrous porous layer may independently have an average fiber diameter in one or more of the above-referenced ranges. Additionally, in some embodiments, all of the fibers together in a fibrous porous layer may have an average fiber diameter in one or more of the above-referenced ranges. When a battery separator comprises two or more fibrous porous layers, each fibrous porous layer may independently comprise fibers having an average fiber diameter in one or more of the above-referenced ranges and/or may comprise a combination of fibers that together have an average fiber diameter in one or more of the above-referenced ranges.

Fibers in a porous fibrous layer may have a variety of suitable average fiber lengths. In some embodiments, fibers in a porous fibrous layer have an average fiber length of greater than or equal to 1 mm, greater than or equal to 2 mm, greater than or equal to 5 mm, greater than or equal to 7.5 mm, greater than or equal to 10 mm, greater than or equal to 20 mm, greater than or equal to 50 mm, greater than or equal to 60 mm, or greater than or equal to 75 mm. In some embodiments, fibers in a porous fibrous layer have an average fiber length of less than or equal to 90 mm, less than or equal to 75 mm, less than or equal to 60 mm, less than or equal to 50 mm, less than or equal to 20 mm, less than or equal to 10 mm, less than or equal to 7.5 mm, less than or equal to 5 mm, or less than or equal to 2 mm. Combinations of the above-referenced ranges are also possible (e.g., greater than or equal to 1 mm and less than or equal to 90 mm). Other ranges are also possible.

Each type of fiber present in a fibrous porous layer may independently have an average fiber length in one or more of the above-referenced ranges. Additionally, in some embodiments, all of the fibers together in a fibrous porous layer may have an average fiber length in one or more of the above-referenced ranges. When a battery separator comprises two or more fibrous porous layers, each fibrous porous layer may independently comprise fibers having an average fiber length in one or more of the above-referenced ranges and/or may comprise a combination of fibers that together have an average fiber length in one or more of the above-referenced ranges.

Fibrous porous layers described herein may comprise fibers of a variety of suitable types. For instance, fibrous porous layers may comprise glass fibers (e.g., microglass fibers, chopped strand glass fibers), types of inorganic fibers other than glass fibers (e.g., rock wool fibers), natural fibers, and/or synthetic fibers (e.g., monocomponent synthetic fibers, multicomponent synthetic fibers).

Glass fibers may make up a variety of suitable percentages of the porous layers described herein. In some embodiments, glass fibers make up greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers present in a fibrous porous layer. In some embodiments, glass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, or less than or equal to 7.5 wt % of the fibers present in a fibrous porous layer. Combinations of the above-referenced ranges are also possible (e.g., greater than or equal to 5 wt % and less than or equal to 100 wt %, or greater than or equal to 5 wt % and less than or equal to 50 wt %). Other ranges are also possible. In some embodiments, glass fibers make up identically 100 wt % of the fibers in a fibrous porous layer.

Each type of glass fiber present in a fibrous porous layer may independently make up a wt % of the fibrous porous layer in one or more of the above-referenced ranges. Additionally, in some embodiments, all of the types of glass fibers together in a fibrous porous layer may make up a wt % of the fibrous porous layer in one or more of the above-referenced ranges. When a battery separator comprises two or more fibrous porous layers, each fibrous porous layer may independently comprise one or more types of glass fibers individually in an amount in one or more of the above-referenced ranges and/or may comprise a combination of types of glass fibers that are present together in an amount in one or more of the above-referenced ranges.

Glass fibers present in a porous layer may have a variety of suitable average fiber diameters. In some embodiments, a porous layer comprises glass fibers having an average fiber diameter of greater than or equal to 0.1 micron, greater than or equal to 0.2 microns, greater than or equal to 0.5 microns, greater than or equal to 0.75 microns, greater than or equal to 1 micron, greater than or equal to 1.5 microns, greater than or equal to 2 microns, greater than or equal to 2.5 microns, greater than or equal to 3 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, a porous layer comprises glass fibers having an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 20 microns). Other ranges are also possible.

Each type of glass fiber present in a fibrous porous layer may independently have an average fiber diameter in one or more of the above-referenced ranges. Additionally, in some embodiments, all of the glass fibers together in a fibrous porous layer may have an average fiber diameter in one or more of the above-referenced ranges. When a battery separator comprises two or more fibrous porous layers, each fibrous porous layer may independently comprise glass fibers having an average fiber diameter in one or more of the above-referenced ranges and/or may comprise a combination of glass fibers that together have an average fiber diameter in one or more of the above-referenced ranges.

Glass fibers present in a porous layer may have a variety of suitable average fiber lengths. In some embodiments, a porous layer comprises glass fibers having an average fiber length of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, greater than or equal to 20 mm, greater than or equal to 30 mm, greater than or equal to 40 mm, greater than or equal to 50 mm, greater than or equal to 60 mm, greater than or equal to 70 mm, or greater than or equal to 80 mm. In some embodiments, a porous layer comprises glass fibers having an average fiber length of less than or equal to 90 mm, less than or equal to 80 mm, less than or equal to 70 mm, less than or equal to 60 mm, less than or equal to 50 mm, less than or equal to 40 mm, less than or equal to 30 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 90 mm). Other ranges are also possible.

Each type of glass fiber present in a fibrous porous layer may independently have an average fiber length in one or more of the above-referenced ranges. Additionally, in some embodiments, all of the glass fibers together in a fibrous porous layer may have an average fiber length in one or more of the above-referenced ranges. When a battery separator comprises two or more fibrous porous layers, each fibrous porous layer may independently comprise glass fibers having an average fiber length in one or more of the above-referenced ranges and/or may comprise a combination of glass fibers that together have an average fiber length in one or more of the above-referenced ranges.

As described above, some porous layers comprise glass fibers that are microglass fibers. Suitable microglass fibers may be fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are M glass fibers according to Man Made Vitreous Fibers by Nomenclature Committee of TIMA Inc. March 1993, Page 45 and C glass fibers (e.g., Lauscha C glass fibers, JM 253 C glass fibers). It should be understood that a plurality of microglass fibers may comprise one or more of the types of microglass fibers described herein.

Microglass fibers may make up a variety of suitable percentages of the porous layers described herein. In some embodiments, microglass fibers make up greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fibers present in a fibrous porous layer. In some embodiments, microglass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, or less than or equal to 7.5 wt % of the fibers present in a fibrous porous layer. Combinations of the above-referenced ranges are also possible (e.g., greater than or equal to 5 wt % and less than or equal to 100 wt %, or greater than or equal to 5 wt % and less than or equal to 50 wt %). Other ranges are also possible. In some embodiments, microglass fibers make up identically 100 wt % of the fibers in a fibrous porous layer.

Each type of microglass fiber present in a fibrous porous layer may independently make up a wt % of the fibrous porous layer in one or more of the above-referenced ranges. Additionally, in some embodiments, all of the types of microglass fibers together in a fibrous porous layer may make up a wt % of the fibrous porous layer in one or more of the above-referenced ranges. When a battery separator comprises two or more fibrous porous layers, each fibrous porous layer may independently comprise one or more types of microglass fibers individually in an amount in one or more of the above-referenced ranges and/or may comprise a combination of types of microglass fibers that are present together in an amount in one or more of the above-referenced ranges.

Microglass fibers present in a porous layer may have a variety of suitable average fiber diameters. In some embodiments, a porous layer comprises microglass fibers having an average fiber diameter of greater than or equal to 0.1 micron, greater than or equal to 0.2 microns, greater than or equal to 0.5 microns, greater than or equal to 0.75 microns, greater than or equal to 1 micron, greater than or equal to 1.5 microns, greater than or equal to 2 microns, or greater than or equal to 2.5 microns. In some embodiments, a porous layer comprises microglass fibers having an average fiber diameter of less than or equal to 3 microns, less than or equal to 2.5 microns, less than or equal to 2 microns, less than or equal to 1.5 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 3 microns, or greater than or equal to 0.5 microns and less than or equal to 3 microns). Other ranges are also possible.

Each type of microglass fiber present in a fibrous porous layer may independently have an average fiber diameter in one or more of the above-referenced ranges. Additionally, in some embodiments, all of the microglass fibers together in a fibrous porous layer may have an average fiber diameter in one or more of the above-referenced ranges. When a battery separator comprises two or more fibrous porous layers, each fibrous porous layer may independently comprise microglass fibers having an average fiber diameter in one or more of the above-referenced ranges and/or may comprise a combination of microglass fibers that together have an average fiber diameter in one or more of the above-referenced ranges.

Microglass fibers present in a porous layer may have a variety of suitable average fiber lengths. In some embodiments, a porous layer comprises microglass fibers having an average fiber length of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 15 mm, greater than or equal to 20 mm, greater than or equal to 30 mm, greater than or equal to 40 mm, greater than or equal to 50 mm, greater than or equal to 60 mm, greater than or equal to 70 mm, or greater than or equal to 80 mm. In some embodiments, a porous layer comprises microglass fibers having an average fiber length of less than or equal to 90 mm, less than or equal to 80 mm, less than or equal to 70 mm, less than or equal to 60 mm, less than or equal to 50 mm, less than or equal to 40 mm, less than or equal to 30 mm, less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 90 mm, or greater than or equal to 30 mm and less than or equal to 90 mm). Other ranges are also possible.

Each type of microglass fiber present in a fibrous porous layer may independently have an average fiber length in one or more of the above-referenced ranges. Additionally, in some embodiments, all of the microglass fibers together in a fibrous porous layer may have an average fiber length in one or more of the above-referenced ranges. When a battery separator comprises two or more fibrous porous layers, each fibrous porous layer may independently comprise microglass fibers having an average fiber length in one or more of the above-referenced ranges and/or may comprise a combination of microglass fibers that together have an average fiber length in one or more of the above-referenced ranges.

As described above, some porous layers comprise glass fibers that are chopped strand glass fibers. The chopped strand glass fibers may comprise chopped strand glass fibers which were produced by drawing a melt of glass from bushing tips into continuous fibers and then cutting the continuous fibers into short fibers. In some embodiments, a porous layer comprises chopped strand glass fibers for which alkali metal oxides (e.g., sodium oxides, magnesium oxides) make up a relatively low amount of the fibers. It is also possible for a porous layer to comprise chopped strand glass fibers that include relatively large amounts of calcium oxide and/or alumina (Al₂O₃). In some embodiments, a porous layer comprises S-glass fibers, which include approximately 10 wt % magnesium oxide. It should be understood that chopped strand glass fibers present in a porous layer may comprise one or more of the types of chopped strand glass fibers described herein.

Chopped strand glass fibers may make up a variety of suitable percentages of the porous layers described herein. In some embodiments, chopped strand glass fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, or greater than or equal to 35 wt % of the fibers present in a fibrous porous layer. In some embodiments, chopped strand glass fibers make up less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 2 wt % of the fibers present in a fibrous porous layer. Combinations of the above-referenced ranges are also possible (e.g., greater than or equal to 0 wt % and less than or equal to 40 wt %, or greater than or equal to 0 wt % and less than or equal to 15 wt %). Other ranges are also possible. In some embodiments, chopped strand glass fibers make up identically 0 wt % of the fibers in a fibrous porous layer.

Each type of chopped strand glass fiber present in a fibrous porous layer may independently make up a wt % of the fibrous porous layer in one or more of the above-referenced ranges. Additionally, in some embodiments, all of the types of chopped strand glass fibers together in a fibrous porous layer may make up a wt % of the fibrous porous layer in one or more of the above-referenced ranges. When a battery separator comprises two or more fibrous porous layers, each fibrous porous layer may independently comprise one or more types of chopped strand glass fibers individually in an amount in one or more of the above-referenced ranges and/or may comprise a combination of types of chopped strand glass fibers that are present together in an amount in one or more of the above-referenced ranges.

Chopped strand glass fibers present in a porous layer may have a variety of suitable average fiber diameters. In some embodiments, a porous layer comprises chopped strand glass fibers having an average fiber diameter of greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, a porous layer comprises chopped strand glass fibers having an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 20 microns). Other ranges are also possible.

Each type of chopped strand glass fiber present in a fibrous porous layer may independently have an average fiber diameter in one or more of the above-referenced ranges. Additionally, in some embodiments, all of the chopped strand glass fibers together in a fibrous porous layer may have an average fiber diameter in one or more of the above-referenced ranges. When a battery separator comprises two or more fibrous porous layers, each fibrous porous layer may independently comprise chopped strand glass fibers having an average fiber diameter in one or more of the above-referenced ranges and/or may comprise a combination of chopped strand glass fibers that together have an average fiber diameter in one or more of the above-referenced ranges.

Chopped strand glass fibers present in a porous layer may have a variety of suitable average fiber lengths. In some embodiments, a porous layer comprises chopped strand glass fibers having an average fiber length of greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, greater than or equal to 22.5 mm, greater than or equal to 25 mm, or greater than or equal to 27.5 mm. In some embodiments, a porous layer comprises chopped strand glass fibers having an average fiber length of less than or equal to 30 mm, less than or equal to 27.5 mm, less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, or less than or equal to 7.5 mm. Combinations of the above-referenced ranges are also possible (e.g., greater than or equal to 5 mm and less than or equal to 30 mm). Other ranges are also possible.

Each type of chopped strand glass fiber present in a fibrous porous layer may independently have an average fiber length in one or more of the above-referenced ranges. Additionally, in some embodiments, all of the chopped strand glass fibers together in a fibrous porous layer may have an average fiber length in one or more of the above-referenced ranges. When a battery separator comprises two or more fibrous porous layers, each fibrous porous layer may independently comprise chopped strand glass fibers having an average fiber length in one or more of the above-referenced ranges and/or may comprise a combination of chopped strand glass fibers that together have an average fiber length in one or more of the above-referenced ranges. Suitable natural fibers may include natural cellulose fibers, jute fibers, and/or wool. When a fibrous porous layer comprises natural cellulose fibers, the natural cellulose fibers may be wood (e.g., cedar) fibers, such as softwood fibers and/or hardwood fibers.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, TN; Robur Flash fibers can be obtained from Rottneros AB, Stockholm, Sweden; and Brunswick pine fibers can be obtained from Georgia-Pacific, Atlanta, GA.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, CT (“Westvaco fibers”), and (6) Georgia-Pacific, Atlanta, GA (“Leaf River fibers”).

Cellulose fibers may make up a variety of suitable percentages of the porous layers described herein. In some embodiments, cellulose fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt % of the fibers present in a fibrous porous layer. In some embodiments, cellulose fibers make up less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than nor equal to 20 wt %, less than or equal to 15 wt %, less than or equal to 10 wt %, less than or equal to 7.5 wt %, less than or equal to 5 wt5, less than or equal to 2 wt %, or less than or equal to 1 wt % of the fibers present in a fibrous porous layer. Combinations of the above-referenced ranges are also possible (e.g., greater than or equal to 0 wt % and less than or equal to 90 wt %). Other ranges are also possible. In some embodiments, cellulose fibers make up identically 0 wt % of the fibers in a fibrous porous layer.

Each type of cellulose fiber present in a fibrous porous layer may independently make up a wt % of the fibrous porous layer in one or more of the above-referenced ranges. Additionally, in some embodiments, all of the types of cellulose fibers together in a fibrous porous layer may make up a wt % of the fibrous porous layer in one or more of the above-referenced ranges. When a battery separator comprises two or more fibrous porous layers, each fibrous porous layer may independently comprise one or more types of cellulose fibers individually in an amount in one or more of the above-referenced ranges and/or may comprise a combination of types of cellulose fibers that are present together in an amount in one or more of the above-referenced ranges.

Cellulose fibers present in a porous layer may have a variety of suitable average fiber diameters. In some embodiments, a porous layer comprises cellulose fibers having an average fiber diameter of greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, or greater than or equal to 17.5 microns. In some embodiments, a porous layer comprises cellulose fibers having an average fiber diameter of less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than nor equal to 0.2 microns, less than or equal to 0.1 micron, or less than or equal to 0.075 microns. Combinations of the above-referenced ranges are also possible (e.g., greater than or equal to 0.05 microns and less than or equal to 20 microns). Other ranges are also possible.

Each type of cellulose fiber present in a fibrous porous layer may independently have an average fiber diameter in one or more of the above-referenced ranges. Additionally, in some embodiments, all of the cellulose fibers together in a fibrous porous layer may have an average fiber diameter in one or more of the above-referenced ranges. When a battery separator comprises two or more fibrous porous layers, each fibrous porous layer may independently comprise cellulose fibers having an average fiber diameter in one or more of the above-referenced ranges and/or may comprise a combination of cellulose fibers that together have an average fiber diameter in one or more of the above-referenced ranges.

Cellulose fibers present in a porous layer may have a variety of suitable average fiber lengths. In some embodiments, a porous layer comprises cellulose fibers having an average fiber length of greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, or greater than or equal to 17.5 mm. In some embodiments, a porous layer comprises cellulose fibers having an average fiber length of less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, or less than or equal to 2 mm. Combinations of the above-referenced ranges are also possible (e.g., greater than or equal to 1 mm and less than or equal to 20 mm). Other ranges are also possible.

Each type of cellulose fiber present in a fibrous porous layer may independently have an average fiber length in one or more of the above-referenced ranges. Additionally, in some embodiments, all of the cellulose fibers together in a fibrous porous layer may have an average fiber length in one or more of the above-referenced ranges. When a battery separator comprises two or more fibrous porous layers, each fibrous porous layer may independently comprise cellulose fibers having an average fiber length in one or more of the above-referenced ranges and/or may comprise a combination of cellulose fibers that together have an average fiber length in one or more of the above-referenced ranges.

Monocomponent synthetic fibers may make up a variety of suitable percentages of the porous layers described herein. In some embodiments, monocomponent synthetic fibers make up greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, or greater than or equal to 32.5 wt % of the fibers present in a fibrous porous layer. In some embodiments, monocomponent synthetic fibers make up less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, or less than or equal to 17.5 wt % of the fibers present in a fibrous porous layer. Combinations of the above-referenced ranges are also possible (e.g., greater than or equal to 15 wt % and less than or equal to 35 wt %). Other ranges are also possible.

Each type of monocomponent synthetic fiber present in a fibrous porous layer may independently make up a wt % of the fibrous porous layer in one or more of the above-referenced ranges. Additionally, in some embodiments, all of the types of monocomponent synthetic fibers together in a fibrous porous layer may make up a wt % of the fibrous porous layer in one or more of the above-referenced ranges. When a battery separator comprises two or more fibrous porous layers, each fibrous porous layer may independently comprise one or more types of monocomponent synthetic fibers individually in an amount in one or more of the above-referenced ranges and/or may comprise a combination of types of monocomponent synthetic fibers that are present together in an amount in one or more of the above-referenced ranges.

Suitable monocomponent synthetic fibers may include monocomponent synthetic fibers comprising one or more of the following types of polymers: poly(vinyl alcohol), poly(ester)s (e.g., poly(ethylene terephthalate)), poly(acrylonitrile), poly(olefin)s (e.g., poly(ethylene), poly(propylene)), poly(vinylidene difluoride), poly(ether sulfone), poly(vinyl chloride), poly(amide)s, poly(imide)s, aramids (e.g., meta-aramids, para-aramids), poly(etherimide), copolymers of the foregoing, and blends of the foregoing.

Monocomponent synthetic fibers present in a porous layer may have a variety of suitable average fiber diameters. In some embodiments, a porous layer comprises monocomponent synthetic fibers having an average fiber diameter of greater than or equal to 0.5 microns, greater than or equal to 1 micron, greater than or equal to 2 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, or greater than or equal to 32.5 microns. In some embodiments, a porous layer comprises monocomponent synthetic fibers having an average fiber diameter of less than or equal to 35 microns, less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 2 microns, or less than or equal to 1 micron. Combinations of the above-referenced ranges are also possible (e.g., greater than or equal to 0.5 microns and less than or equal to 35 microns, or greater than or equal to 0.5 microns and less than or equal to 20 microns). Other ranges are also possible.

Each type of monocomponent synthetic fiber present in a fibrous porous layer may independently have an average fiber diameter in one or more of the above-referenced ranges. Additionally, in some embodiments, all of the monocomponent synthetic fibers together in a fibrous porous layer may have an average fiber diameter in one or more of the above-referenced ranges. When a battery separator comprises two or more fibrous porous layers, each fibrous porous layer may independently comprise monocomponent synthetic fibers having an average fiber diameter in one or more of the above-referenced ranges and/or may comprise a combination of monocomponent synthetic fibers that together have an average fiber diameter in one or more of the above-referenced ranges.

Monocomponent synthetic fibers present in a porous layer may have a variety of suitable average fiber lengths. In some embodiments, a porous layer comprises monocomponent synthetic fibers that are staple fibers. Some porous layers may comprise monocomponent synthetic fibers having an average fiber length of greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 12 mm, greater than or equal to 15 mm, or greater than or equal to 17.5 mm. Some porous layers may comprise monocomponent synthetic fibers having an average fiber length of less than or equal to 20 mm, less than or equal to 17.5 mm, less than or equal to 15 mm, less than or equal to 12 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1 mm, or less than or equal to 0.75 mm. Combinations of the above-referenced ranges are also possible (e.g., greater than or equal to 0.5 mm and less than or equal to 20 mm, greater than or equal to 3 mm and less than or equal to 12 mm, or greater than or equal to 5 mm and less than or equal to 10 mm). Other ranges are also possible.

Each type of monocomponent synthetic fiber present in a fibrous porous layer may independently have an average fiber length in one or more of the above-referenced ranges. Additionally, in some embodiments, all of the monocomponent synthetic fibers together in a fibrous porous layer may have an average fiber length in one or more of the above-referenced ranges. When a battery separator comprises two or more fibrous porous layers, each fibrous porous layer may independently comprise monocomponent synthetic fibers having an average fiber length in one or more of the above-referenced ranges and/or may comprise a combination of monocomponent synthetic fibers that together have an average fiber length in one or more of the above-referenced ranges.

Multicomponent fibers may make up a variety of suitable percentages of the porous layers described herein. In some embodiments, multicomponent fibers make up greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 11 wt %, greater than or equal to 12 wt %, greater than or equal to 13 wt %, or greater than or equal to 14 wt % of the fibers present in a fibrous porous layer. In some embodiments, multicomponent fibers make up less than or equal to 15 wt %, less than or equal to 14 wt %, less than or equal to 13 wt %, less than or equal to 12 wt %, less than or equal to 11 wt %, less than or equal to 10 wt %, less than or equal to 9 wt %, less than or equal to 8 wt %, less than or equal to 7 wt %, or less than or equal to 6 wt % of the fibers present in a fibrous porous layer. Combinations of the above-referenced ranges are also possible (e.g., greater than or equal to 5 wt % and less than or equal to 15 wt %). Other ranges are also possible.

Each type of multicomponent fiber present in a fibrous porous layer may independently make up a wt % of the fibrous porous layer in one or more of the above-referenced ranges. Additionally, in some embodiments, all of the types of multicomponent fibers together in a fibrous porous layer may make up a wt % of the fibrous porous layer in one or more of the above-referenced ranges. When a battery separator comprises two or more fibrous porous layers, each fibrous porous layer may independently comprise one or more types of multicomponent fibers individually in an amount in one or more of the above-referenced ranges and/or may comprise a combination of types of multicomponent fibers that are present together in an amount in one or more of the above-referenced ranges.

Suitable multicomponent fibers may comprise bicomponent fibers (i.e., fibers including two components), and/or may comprise fibers comprising three or more components. Multicomponent fibers may have a variety of suitable structures. For instance, a fibrous porous layer may comprise one or more of the following types of bicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the non-woven fiber web together while the core remains solid

Non-limiting examples of suitable materials that may be included in multicomponent fibers include poly(olefin)s such as poly(ethylene), poly(propylene), and poly(butylene); poly(ester)s and co-poly(ester)s such as poly(ethylene terephthalate) (e.g., amorphous poly(ethylene terephthalate)), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

The multicomponent fibers described herein may have a variety of suitable melting points and/or comprise components having a variety of suitable melting points. In some embodiments, a fibrous porous layer comprises a multicomponent fiber comprising a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a fibrous porous layer comprises a multicomponent fiber comprising a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible. The melting points of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

Multicomponent fibers present in a porous layer may have a variety of suitable average fiber diameters. In some embodiments, a porous layer comprises multicomponent fibers having an average fiber diameter of greater than or equal 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, or greater than or equal to 32.5 microns. In some embodiments, a porous layer comprises multicomponent fibers having an average fiber diameter of less than or equal to 35 microns, less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, or less than or equal to 7.5 microns. Combinations of the above-referenced ranges are also possible (e.g., greater than or equal to 5 microns and less than or equal to 35 microns, or greater than or equal to 5 microns and less than or equal to 20 microns). Other ranges are also possible.

Each type of multicomponent fiber present in a fibrous porous layer may independently have an average fiber diameter in one or more of the above-referenced ranges. Additionally, in some embodiments, all of the multicomponent fibers together in a fibrous porous layer may have an average fiber diameter in one or more of the above-referenced ranges. When a battery separator comprises two or more fibrous porous layers, each fibrous porous layer may independently comprise multicomponent fibers having an average fiber diameter in one or more of the above-referenced ranges and/or may comprise a combination of multicomponent fibers that together have an average fiber diameter in one or more of the above-referenced ranges.

Multicomponent fibers present in a porous layer may have a variety of suitable average fiber lengths. In some embodiments, a porous layer comprises multicomponent fibers that are staple fibers. Some porous layers may comprise multicomponent fibers having an average fiber length of greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 12 mm, greater than or equal to 15 mm, or greater than or equal to 17.5 mm. Some porous layers may comprise multicomponent fibers having an average fiber length of less than or equal to 20 mm, less than or equal to 17.5 mm, less than or equal to 15 mm, less than or equal to 12 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, less than or equal to 1 mm, or less than or equal to 0.75 mm. Combinations of the above-referenced ranges are also possible (e.g., greater than or equal to 0.5 mm and less than or equal to 20 mm, greater than or equal to 3 mm and less than or equal to 12 mm, or greater than or equal to 5 mm and less than or equal to 10 mm). Other ranges are also possible.

Each type of multicomponent fiber present in a fibrous porous layer may independently have an average fiber length in one or more of the above-referenced ranges. Additionally, in some embodiments, all of the multicomponent fibers together in a fibrous porous layer may have an average fiber length in one or more of the above-referenced ranges. When a battery separator comprises two or more fibrous porous layers, each fibrous porous layer may independently comprise multicomponent fibers having an average fiber length in one or more of the above-referenced ranges and/or may comprise a combination of multicomponent fibers that together have an average fiber length in one or more of the above-referenced ranges.

In some embodiments, a porous layer comprises a filler. The filler may have one or more of the characteristics described above with respect to the types of filler that may be incorporated into the pluralities of ribs described herein. It is also possible for a porous layer to comprise a filler that differs from the fillers described above with respect to the types of filler that may be incorporated into such ribs. Battery separators comprising porous layers comprising a filler may comprise ribs that comprise a filler and/or may comprise ribs that lack filler. Additionally, a battery separator may comprise both a plurality of ribs and a porous layer that comprise the same type of filler and/or may comprise a plurality of ribs that comprises a different type of filler than a type of filler included in a porous layer also positioned therein.

One or more fillers may make up a variety of suitable percentages of the porous layers described herein. In some embodiments, one or more fillers make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of a porous layer. In some embodiments, one or more fillers make up less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of a porous layer. Combinations of the above-referenced ranges are also possible (e.g., greater than or equal to 0 wt % and less than or equal to 60 wt %, or greater than or equal to 30 wt % and less than or equal to 60 wt %). Other ranges are also possible. In some embodiments, one or more fillers make up identically 0 wt % of a porous layer.

Each filler present in a porous layer may independently make up a wt % of the porous layer in one or more of the above-referenced ranges. Additionally, in some embodiments, all of the fillers together in a porous layer may make up a wt % of the ribs in one or more of the above-referenced ranges. When a battery separator comprises two or more porous layers, each porous layer may independently comprise one or more fillers individually in an amount in one or more of the above-referenced ranges and/or may comprise a combination of fillers that are present together in an amount in one or more of the above-referenced ranges.

The porous layers described herein may have a variety of suitable physical properties. Further details regarding the physical properties of some porous layers are described in further detail below.

The porous layers described herein may have a variety of suitable porosities. In some embodiments, a porous layer has a porosity of greater than or equal to 10%, greater than or equal to 12.5%, greater than or equal to 15%, greater than or equal to 17.5%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, or greater than or equal to 95%. In some embodiments, a porous layer has a porosity of less than or equal to 98%, less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 17.5%, less than or equal to 15%, or less than or equal to 12.5%. Combinations of the above-referenced ranges are also possible (e.g., greater than or equal to 10% and less than or equal to 98%, greater than or equal to 20% and less than or equal to 80%, greater than or equal to 25% and less than or equal to 60%, greater than or equal to 25% and less than or equal to 50%, greater than or equal to 30% and less than or equal to 70%, or greater than or equal to 40% and less than or equal to 70%). Other ranges are also possible.

The porosity of a porous layer may be determined in accordance with BCIS-03B (2015).

When a battery separator comprises two or more porous layers, each porous layer may independently have a porosity in one or more of the above-referenced ranges.

The porous layers described herein may have a variety of suitable mean flow pore sizes. In some embodiments, a porous layer has a mean flow pore size of greater than or equal to 0.05 microns, greater than or equal to 0.075 microns, greater than or equal to 0.1 micron, greater than or equal to 0.2 microns, greater than or equal to 0.5 microns, greater than or equal to 0.75 microns, greater than or equal to 1 micron, greater than or equal to 1.5 microns, greater than or equal to 2 microns, greater than or equal to 2.5 microns, greater than or equal to 3 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, greater than or equal to 45 microns, greater than or equal to 50 microns, or greater than or equal to 60 microns. In some embodiments, a porous layer has a mean flow pore size of less than or equal to 75 microns, less than or equal to 60 microns, less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1 micron, less than or equal to 0.75 microns, less than or equal to 0.2 microns, less than or equal to 0.1 micron, or less than or equal to 0.075 microns. Combinations of the above-referenced ranges are also possible (e.g., greater than or equal to 0.05 microns and less than or equal to 75 microns, greater than or equal to 0.05 microns and less than or equal to 1 micron, greater than or equal to 0.05 microns and less than or equal to 50 microns, greater than or equal to 1 micron and less than or equal to 25 microns, greater than or equal to 2 microns and less than or equal to 10 microns, or greater than or equal to 2.5 microns and less than or equal to 75 microns). Other ranges are also possible.

The mean flow pore size of a porous layer may be determined in accordance with ASTM F316 (2003).

When a battery separator comprises two or more porous layers, each porous layer may independently have a mean flow pore size in one or more of the above-referenced ranges.

The porous layers described herein may have a variety of suitable maximum pore sizes. In some embodiments, a porous layer has a maximum pore size of greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, greater than or equal to 80 microns, greater than or equal to 100 microns, greater than or equal to 150 microns, greater than or equal to 200 microns, greater than or equal to 250 microns, greater than or equal to 300 microns, greater than or equal to 350 microns, greater than or equal to 400 microns, or greater than or equal to 450 microns. In some embodiments, a porous layer has a maximum pore size of less than or equal to 500 microns, less than or equal to 450 microns, less than or equal to 400 microns, less than or equal to 350 microns, less than or equal to 300 microns, less than or equal to 250 microns, less than or equal to 200 microns, less than or equal to 150 microns, less than or equal to 100 microns, less than or equal to 80 microns, less than or equal to 60 microns, less than or equal to 50 microns, less than or equal to 40 microns, less than or equal to 30 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, or less than or equal to 0.75 microns. Combinations of the above-referenced ranges are also possible (e.g., greater than or equal to 0.5 microns and less than or equal to 500 microns, greater than or equal to 10 microns and less than or equal to 250 microns, or greater than or equal to 50 and less than or equal to 100 microns). Other ranges are also possible.

The maximum pore size of a porous layer may be determined in accordance with ASTM F316 (2003).

When a battery separator comprises two or more porous layers, each porous layer may independently have a maximum pore size in one or more of the above-referenced ranges.

The porous layers described herein may have a variety of suitable ratios of maximum pore size to mean flow pore size. In some embodiments, a porous layer has a ratio of maximum pore size to mean flow pore size of greater than or equal to 1, greater than or equal to 2, greater than or equal to 5, greater than or equal to 7.5, greater than or equal to 10, greater than or equal to 12.5, greater than or equal to 15, greater than or equal to 17.5, greater than or equal to 20, greater than or equal to 25, greater than or equal to 30, greater than or equal to 40, greater than or equal to 50, greater than or equal to 60, greater than or equal to 80, greater than or equal to 100, greater than or equal to 150, greater than or equal to 200, greater than or equal to 250, greater than or equal to 300, greater than or equal to 400, greater than or equal to 500, greater than or equal to 600, or greater than or equal to 800. In some embodiments, a porous layer has a ratio of maximum pore size to mean flow pore size of less than or equal to 1000, less than or equal to 800, less than or equal to 600, less than or equal to 500, less than or equal to 400, less than or equal to 300, less than or equal to 250, less than or equal to 200, less than or equal to 150, less than or equal to 100, less than or equal to 80, less than or equal to 60, less than or equal to 50, less than or equal to 40, less than or equal to 30, less than or equal to 25, less than or equal to 20, less than or equal to 17.5, less than or equal to 15, less than or equal to 12.5, less than or equal to 10, less than or equal to 7.5, less than or equal to 5, or less than or equal to 2. Combinations of the above-referenced ranges are also possible (e.g., greater than or equal to 1 and less than or equal to 1000, greater than or equal to 10 and less than or equal to 500, or greater than or equal to 20 and less than or equal to 100). Other ranges are also possible.

The ratio of maximum pore size to mean flow pore size for a porous layer may be determined by dividing the maximum pore size by the mean flow pore size.

When a battery separator comprises two or more porous layers, each porous layer may independently have a ratio of maximum pore size to mean flow pore size in one or more of the above-referenced ranges.

The porous layers described herein may have a variety of suitable basis weights. In some embodiments, a porous layer has a basis weight of greater than or equal to 10 gsm, greater than or equal to 20 gsm, greater than or equal to 30 gsm, greater than or equal to 40 gsm, greater than or equal to 50 gsm, greater than or equal to 60 gsm, greater than or equal to 80 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 500 gsm, or greater than or equal to 600 gsm. In some embodiments, a porous layer has a basis weight of less than or equal to 700 gsm, less than or equal to 600 gsm, less than or equal to 500 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 80 gsm, less than or equal to 60 gsm, less than or equal to 50 gsm, less than or equal to 40 gsm, less than or equal to 30 gsm, or less than or equal to 20 gsm. Combinations of the above-referenced ranges are also possible (e.g., greater than or equal to 10 gsm and less than or equal to 700 gsm, greater than or equal to 50 gsm and less than or equal to 500 gsm, or greater than or equal to 100 gsm and less than or equal to 300 gsm).

The basis weight of a porous layer may be determined according to the standard ISO 536:2012.

When a battery separator comprises two or more porous layers, each porous layer may independently have a basis weight in one or more of the above-referenced ranges.

The porous layers described herein may have a variety of suitable thicknesses. In some embodiments, a porous layer has a thickness of greater than or equal to 0.05 mm, greater than or equal to 0.075 mm, greater than or equal to 0.1 mm, greater than or equal to 0.2 mm, greater than or equal to 0.3 mm, greater than or equal to 0.5 mm, greater than or equal to 0.75 mm, greater than or equal to 1 mm, greater than or equal to 1.5 mm, greater than or equal to 2 mm, greater than or equal to 2.5 mm, greater than or equal to 3 mm, greater than or equal to 3.5 mm, greater than or equal to 4 mm, greater than or equal to 4.5 mm, greater than or equal to 5 mm, or greater than or equal to 5.5 mm. In some embodiments, a porous layer has a thickness of less than or equal to 6 mm, less than or equal to 5.5 mm, less than or equal to 5 mm, less than or equal to 4.5 mm, less than or equal to 4 mm, less than or equal to 3.5 mm, less than or equal to 3 mm, less than or equal to 2.5 mm, less than or equal to 2 mm, less than or equal to 1.5 mm, less than or equal to 1 mm, less than or equal to 0.75 mm, less than or equal to 0.5 mm, less than or equal to 0.3 mm, less than or equal to 0.2 mm, less than or equal to 0.1 mm, or less than or equal to 0.075 mm. Combinations of the above-referenced ranges are also possible (e.g., greater than or equal to 0.05 mm and less than or equal to 6 mm, greater than or equal to 0.1 mm and less than or equal to 4 mm, or greater than or equal to 0.3 mm and less than or equal to 2 mm). Other ranges are also possible.

The thickness of a porous layer may be determined in accordance with BCIS-03A, Sept-09, Method 10 under 10 kPa applied pressure.

When a battery separator comprises two or more porous layers, each porous layer may independently have a thickness in one or more of the above-referenced ranges.

The porous layers described herein may have a variety of suitable specific surface areas. In some embodiments, a porous layer has a specific surface area of greater than or equal to 0.05 m²/g, greater than or equal to 0.075 m²/g, greater than or equal to 0.1 m²/g, greater than or equal to 0.2 m²/g, greater than or equal to 0.5 m²/g, greater than or equal to 0.75 m²/g, greater than or equal to 1 m²/g, greater than or equal to 2 m²/g, greater than or equal to 5 m²/g, greater than or equal to 7.5 m²/g, greater than or equal to 10 m²/g, greater than or equal to 20 m²/g, greater than or equal to 50 m²/g, greater than or equal to 75 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, or greater than or equal to 450 m²/g. In some embodiments, a porous layer has a specific surface area of less than or equal to 500 m²/g, less than or equal to 450 m²/g, less than or equal to 400 m²/g, less than or equal to 350 m²/g, less than or equal to 300 m²/g, less than or equal to 250 m²/g, less than or equal to 200 m²/g, less than or equal to 150 m²/g, less than or equal to 100 m²/g, less than or equal to 75 m²/g, less than or equal to 50 m²/g, less than or equal to 20 m²/g, less than or equal to 10 m²/g, less than or equal to 7.5 m²/g, less than or equal to 5 m²/g, less than or equal to 2 m²/g, less than or equal to 1 m²/g, less than or equal to 0.75 m²/g, less than or equal to 0.5 m²/g, less than or equal to 0.2 m²/g, less than or equal to 0.1 m²/g, or less than or equal to 0.075 m²/g. Combinations of the above-referenced ranges are also possible (e.g., greater than or equal to 0.05 m²/g and less than or equal to 500 m²/g, greater than or equal to 0.5 m²/g and less than or equal to 300 m²/g, or greater than or equal to 1 m²/g and less than or equal to 250 m²/g). Other ranges are also possible.

The specific surface area of a porous layer may be determined by the same procedure described elsewhere herein for determining the specific surface area of a filler.

When a battery separator comprises two or more porous layers, each porous layer may independently have a specific surface area in one or more of the above-referenced ranges.

The porous layers described herein may have a variety of suitable air permeabilities. In some embodiments, a porous layer has an air permeability of greater than or equal to 0.05 CFM (cfm/sf), greater than or equal to 0.075 CFM, greater than or equal to 0.1 CFM, greater than or equal to 0.2 CFM, greater than or equal to 0.5 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 200 CFM, greater than or equal to 500 CFM, or greater than or equal to 750 CFM. In some embodiments, a porous layer has an air permeability of less than or equal to 1000 CFM, less than or equal to 750 CFM, less than or equal to 500 CFM, less than or equal to 200 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.5 CFM, less than or equal to 0.2 CFM, less than or equal to 0.1 CFM, or less than or equal to 0.075 CFM. Combinations of the above-referenced ranges are also possible (e.g., greater than or equal to 0.05 CFM and less than or equal to 1000 CFM, greater than or equal to 0.1 CFM and less than or equal to 100 CFM, or greater than or equal to 0.2 CFM and less than or equal to 20 CFM). Other ranges are also possible.

The air permeability of a porous layer may be determined in accordance with ASTM Test Standard D737-04 (2016) at a pressure of 125 Pa.

When a battery separator comprises two or more porous layers, each porous layer may independently have an air permeability in one or more of the above-referenced ranges.

The porous layers described herein may have a variety of suitable tensile strengths in the machine direction. In some embodiments, a porous layer has a tensile strength in the machine direction of greater than or equal to 5 lbs/in, greater than or equal to 7.5 lbs/in, greater than or equal to 10 lbs/in, greater than or equal to 12.5 lbs/in, greater than or equal to 15 lbs/in, greater than or equal to 17.5 lbs/in, greater than or equal to 20 lbs/in, greater than or equal to 25 lbs/in, greater than or equal to 30 lbs/in, greater than or equal to 40 lbs/in, greater than or equal to 50 lbs/in, greater than or equal to 75 lbs/in, greater than or equal to 100 lbs/in, greater than or equal to 150 lbs/in, greater than or equal to 200 lbs/in, greater than or equal to 250 lbs/in, or greater than or equal to 300 lbs/in. In some embodiments, a porous layer has a tensile strength in the machine direction of less than or equal to 350 lbs/in, less than or equal to 300 lbs/in, less than or equal to 250 lbs/in, less than or equal to 200 lbs/in, less than or equal to 150 lbs/in, less than or equal to 100 lbs/in, less than or equal to 75 lbs/in, less than or equal to 50 lbs/in, less than or equal to 40 lbs/in, less than or equal to 30 lbs/in, less than or equal to 25 lbs/in, less than or equal to 20 lbs/in, less than or equal to 17.5 lbs/in, less than or equal to 15 lbs/in, less than or equal to 12.5 lbs/in, less than or equal to 10 lbs/in, or less than or equal to 7.5 lbs/in. Combinations of the above-referenced ranges are also possible (e.g., greater than or equal to 5 lbs/in and less than or equal to 350 lbs/in, greater than or equal to 10 lbs/in and less than or equal to 200 lbs/in, or greater than or equal to 15 lbs/in and less than or equal to 100 lbs/in). Other ranges are also possible.

The tensile strength in the machine direction of a porous layer may be determined in accordance with BCIS 03B (2018).

When a battery separator comprises two or more porous layers, each porous layer may independently have a tensile strength in the machine direction in one or more of the above-referenced ranges.

The porous layers described herein may have a variety of suitable tensile strengths in the cross direction. In some embodiments, a porous layer has a tensile strength in the cross direction of greater than or equal to 1 lb/in, greater than or equal to 1.5 lbs/in, greater than or equal to 2 lbs/in, greater than or equal to 3 lbs/in, greater than or equal to 4 lbs/in, greater than or equal to 5 lbs/in, greater than or equal to 7.5 lbs/in, greater than or equal to 10 lbs/in, greater than or equal to 12.5 lbs/in, greater than or equal to 15 lbs/in, greater than or equal to 17.5 lbs/in, greater than or equal to 20 lbs/in, greater than or equal to 25 lbs/in, greater than or equal to 30 lbs/in, greater than or equal to 40 lbs/in, greater than or equal to 50 lbs/in, greater than or equal to 75 lbs/in, greater than or equal to 100 lbs/in, greater than or equal to 150 lbs/in, greater than or equal to 200 lbs/in, greater than or equal to 250 lbs/in, or greater than or equal to 300 lbs/in. In some embodiments, a porous layer has a tensile strength in the cross direction of less than or equal to 350 lbs/in, less than or equal to 300 lbs/in, less than or equal to 250 lbs/in, less than or equal to 200 lbs/in, less than or equal to 150 lbs/in, less than or equal to 100 lbs/in, less than or equal to 75 lbs/in, less than or equal to 50 lbs/in, less than or equal to 40 lbs/in, less than or equal to 30 lbs/in, less than or equal to 25 lbs/in, less than or equal to 20 lbs/in, less than or equal to 17.5 lbs/in, less than or equal to 15 lbs/in, less than or equal to 12.5 lbs/in, less than or equal to 10 lbs/in, less than or equal to 7.5 lbs/in, less than or equal to 5 lbs/in, less than or equal to 4 lbs/in, less than or equal to 3 lbs/in, less than or equal to 2 lbs/in, or less than or equal to 1.5 lbs/in. Combinations of the above-referenced ranges are also possible (e.g., greater than or equal to 1 lb/in and less than or equal to 350 lbs/in, greater than or equal to 2 lbs/in and less than or equal to 200 lbs/in, or greater than or equal to 4 lbs/in and less than or equal to 100 lbs/in). Other ranges are also possible.

The tensile strength in the cross direction of a porous layer may be determined in accordance with BCIS 03B (2018).

When a battery separator comprises two or more porous layers, each porous layer may independently have a tensile strength in the cross direction in one or more of the above-referenced ranges.

The porous layers described herein may have a variety of suitable Gurley stiffnesses. In some embodiments, a porous layer has a Gurley stiffness of greater than or equal to 50 mg, greater than or equal to 100 mg, greater than or equal to 150 mg, greater than or equal to 200 mg, greater than or equal to 250 mg, greater than or equal to 300 mg, greater than or equal to 400 mg, greater than or equal to 500 mg, greater than or equal to 600 mg, greater than or equal to 800 mg, greater than or equal to 1000 mg, greater than or equal to 1500 mg, greater than or equal to 2000 mg, greater than or equal to 2500 mg, greater than or equal to 3000 mg, greater than or equal to 4000 mg, or greater than or equal to 5000 mg. In some embodiments, a porous layer has a Gurley stiffness of less than or equal to 6000 mg, less than or equal to 5000 mg, less than or equal to 4000 mg, less than or equal to 3000 mg, less than or equal to 2500 mg, less than or equal to 2000 mg, less than or equal to 1500 mg, less than or equal to 1000 mg, less than or equal to 800 mg, less than or equal to 600 mg, less than or equal to 500 mg, less than or equal to 400 mg, less than or equal to 300 mg, less than or equal to 250 mg, less than or equal to 200 mg, or less than or equal to 150 mg. Combinations of the above-referenced ranges are also possible (e.g., greater than or equal to 50 mg and less than or equal to 6000 mg, greater than or equal to 100 mg and less than or equal to 6000 mg, greater than or equal to 100 mg and less than or equal to 4000 mg, greater than or equal to 200 mg and less than or equal to 4000 mg, or greater than or equal to 500 mg and less than or equal to 2000 mg). Other ranges are also possible.

The Gurley stiffness of a porous layer may be determined in accordance with TAPPI T543 om-94 (1994).

When a battery separator comprises two or more porous layers, each porous layer may independently have a Gurley stiffness in one or more of the above-referenced ranges.

The porous layers described herein may have a variety of suitable elongations at break in the machine direction. In some embodiments, a porous layer has an elongation at break in the machine direction of greater than or equal to 0.05%, greater than or equal to 0.075%, greater than or equal to 0.1%, greater than or equal to 0.2%, greater than or equal to 0.5%, greater than or equal to 0.75%, greater than or equal to 1%, greater than or equal to 1.5%, greater than or equal to 2%, greater than or equal to 3%, greater than or equal to 5%, greater than or equal to 7.5%, greater than or equal to 10%, greater than or equal to 20%, greater than or equal to 50%, greater than or equal to 75%, greater than or equal to 100%, greater than or equal to 200%, greater than or equal to 300%, or greater than or equal to 400%. In some embodiments, a porous layer has an elongation at break in the machine direction of less than or equal to 500%, less than or equal to 400%, less than or equal to 300%, less than or equal to 200%, less than or equal to 100%, less than or equal to 75%, less than or equal to 50%, less than or equal to 20%, less than or equal to 10%, less than or equal to 7.5%, less than or equal to 5%, less than or equal to 3%, less than or equal to 2%, less than or equal to 1.5%, less than or equal to 1%, less than or equal to 0.75%, less than or equal to 0.5%, less than or equal to 0.2%, less than or equal to 0.1%, or less than or equal to 0.075%. Combinations of the above-referenced ranges are also possible (e.g., greater than or equal to 0.05% and less than or equal to 500%, greater than or equal to 0.5% and less than or equal to 200%, or greater than or equal to 2% and less than or equal to 10%). Other ranges are also possible.

The elongation at break in the machine direction of a porous layer may be determined in accordance with BCIS 03B (2018).

When a battery separator comprises two or more porous layers, each porous layer may independently have an elongation at break in the machine direction in one or more of the above-referenced ranges.

The porous layers described herein may have a variety of suitable elongations at break in the cross direction. In some embodiments, a porous layer has an elongation at break in the cross direction of greater than or equal to 0.1%, greater than or equal to 0.2%, greater than or equal to 0.5%, greater than or equal to 0.75%, greater than or equal to 1%, greater than or equal to 1.5%, greater than or equal to 2%, greater than or equal to 3%, greater than or equal to 5%, greater than or equal to 7.5%, greater than or equal to 10%, greater than or equal to 20%, greater than or equal to 50%, greater than or equal to 75%, greater than or equal to 100%, greater than or equal to 200%, greater than or equal to 300%, greater than or equal to 400%, greater than or equal to 500%, or greater than or equal to 750%. In some embodiments, a porous layer has an elongation at break in the cross direction of less than or equal to 1000%, less than or equal to 750%, less than or equal to 500%, less than or equal to 400%, less than or equal to 300%, less than or equal to 200%, less than or equal to 100%, less than or equal to 75%, less than or equal to 50%, less than or equal to 20%, less than or equal to 10%, less than or equal to 7.5%, less than or equal to 5%, less than or equal to 3%, less than or equal to 2%, less than or equal to 1.5%, less than or equal to 1%, less than or equal to 0.75%, less than or equal to 0.5%, or less than or equal to 0.2%. Combinations of the above-referenced ranges are also possible (e.g., greater than or equal to 0.1% and less than or equal to 1000%, greater than or equal to 1% and less than or equal to 400%, or greater than or equal to 2% and less than or equal to 20%). Other ranges are also possible.

The elongation at break in the cross direction of a porous layer may be determined in accordance with BCIS 03B (2018).

When a battery separator comprises two or more porous layers, each porous layer may independently have an elongation at break in the cross direction in one or more of the above-referenced ranges.

The porous layers described herein may have a variety of suitable puncture strengths. In some embodiments, a porous layer has a puncture strength of greater than or equal to 0.05 N, greater than or equal to 0.075 N, greater than or equal to 0.1 N, greater than or equal to 0.2 N, greater than or equal to 0.5 N, greater than or equal to 0.75 N, greater than or equal to 1 N, greater than or equal to 2 N, greater than or equal to 5 N, greater than or equal to 7.5 N, greater than or equal to 10 N, greater than or equal to 15 N, greater than or equal to 20 N, greater than or equal to 30 N, greater than or equal to 50 N, greater than or equal to 75 N, greater than or equal to 100 N, greater than or equal to 200 N, greater than or equal to 500 N, or greater than or equal to 750 N. In some embodiments, a porous layer has a puncture strength of less than or equal to 1000 N, less than or equal to 750 N, less than or equal to 500 N, less than or equal to 200 N, less than or equal to 100 N, less than or equal to 75 N, less than or equal to 50 N, less than or equal to 30 N, less than or equal to 20 N, less than or equal to 15 N, less than or equal to 10 N, less than or equal to 7.5 N, less than or equal to 5 N, less than or equal to 2 N, less than or equal to 1 N, less than or equal to 0.75 N, less than or equal to 0.5 N, less than or equal to 0.2 N, less than or equal to 0.1 N, or less than or equal to 0.075 N. Combinations of the above-referenced ranges are also possible (e.g., greater than or equal to 0.05 N and less than or equal to 1000 N, greater than or equal to 0.5 N and less than or equal to 20 N, or greater than or equal to 2 N and less than or equal to 10 N). Other ranges are also possible.

The puncture strength of a porous layer may be determined in accordance with BCIS 03B (2018).

When a battery separator comprises two or more porous layers, each porous layer may independently have a puncture strength in one or more of the above-referenced ranges.

The porous layers described herein may have a variety of suitable electrical resistances. In some embodiments, a porous layer has an electrical resistance of greater than or equal to 5 mΩ·cm², greater than or equal to 7.5 mΩ·cm², greater than or equal to 10 mΩ·cm², greater than or equal to 15 mΩ·cm², greater than or equal to 20 mΩ·cm², greater than or equal to 25 mΩ·cm², greater than or equal to 30 mΩ·cm², greater than or equal to 35 mΩ·cm², greater than or equal to 40 mΩ·cm², greater than or equal to 45 mΩ·cm², greater than or equal to 50 mΩ·cm², greater than or equal to 60 mΩ·cm², greater than or equal to 80 mΩ·cm², greater than or equal to 100 mΩ·cm², greater than or equal to 150 mΩ·cm², gat than or equal to 200 mΩ·cm², greater than or equal to 250 mΩ·cm², greater than or equal to 300 mΩ·cm², greater than or equal to 400 mΩ·cm², greater than or equal to 500 mΩ·cm², or greater than or equal to 600 mΩ·cm². In some embodiments, a porous layer has an electrical resistance of less than or equal to 800 mΩ·cm², less than or equal to 600 mΩ·cm², less than or equal to 500 mΩ·cm², less than or equal to 400 mΩ·cm², less than or equal to 300 mΩ·cm², less than or equal to 250 mΩ·cm², less than or equal to 200 mΩ·cm², less than or equal to 150 mΩ·cm², less than or equal to 100 mΩ·cm², less than or equal to 80 mΩ·cm², less than or equal to 60 mΩ·cm², less than or equal to 50 mΩ·cm², less than or equal to 45 mΩ·cm², less than or equal to 40 mΩ·cm², less than or equal to 35 mΩ·cm², less than or equal to 30 mΩ·cm², less than or equal to 25 mΩ·cm², less than or equal to 20 mΩ·cm², less than or equal to 15 mΩ·cm², less than or equal to 10 mΩ·cm², or less than or equal to 7.5 mΩ·cm². Combinations of the above-referenced ranges are also possible (e.g., greater than or equal to 5 mΩ·cm² and less than or equal to 800 mΩ·cm², greater than or equal to 10 mΩ·cm² and less than or equal to 300 mΩ·cm², or greater than or equal to 20 mΩ·cm² and less than or equal to 50 mΩ·cm²). Other ranges are also possible.

The electrical resistance of a porous layer may be determined in accordance with IS 6071-1986.

When a battery separator comprises two or more porous layers, each porous layer may independently have an electrical resistance in one or more of the above-referenced ranges.

The porous layers described herein may have a variety of suitable break down voltages. In some embodiments, a porous layer has a break down voltage of greater than or equal to 0.1 kV, greater than or equal to 0.15 kV, greater than or equal to 0.2 kV, greater than or equal to 0.3 kV, greater than or equal to 0.4 kV, greater than or equal to 0.5 kV, greater than or equal to 0.6 kV, greater than or equal to 0.8 kV, greater than or equal to 1 kV, greater than or equal to 1.5 kV, greater than or equal to 2 kV, greater than or equal to 2.5 kV, greater than or equal to 3 kV, greater than or equal to 4 kV, greater than or equal to 5 kV, greater than or equal to 6 kV, greater than or equal to 8 kV, greater than or equal to 10 kV, greater than or equal to 12.5 kV, greater than or equal to 15 kV, or greater than or equal to 17.5 kV. In some embodiments, a porous layer has a break down voltage of less than or equal to 20 kV, less than or equal to 17.5 kV, less than or equal to 15 kV, less than or equal to 12.5 kV, less than or equal to 10 kV, less than or equal to 8 kV, less than or equal to 6 kV, less than or equal to 5 kV, less than or equal to 4 kV, less than or equal to 3 kV, less than or equal to 2.5 kV, less than or equal to 2 kV, less than or equal to 1.5 kV, less than or equal to 1 kV, less than or equal to 0.8 kV, less than or equal to 0.6 kV, less than or equal to 0.5 kV, less than or equal to 0.4 kV, less than or equal to 0.3 kV, less than or equal to 0.2 kV, or less than or equal to 0.15 kV. Combinations of the above-referenced ranges are also possible (e.g., greater than or equal to 0.1 kV and less than or equal to 20 kV, greater than or equal to 0.2 kV and less than or equal to 10 kV, or greater than or equal to 0.5 kV and less than or equal to 5 kV). Other ranges are also possible.

Briefly, the breakdown voltage of a porous layer can be measured by applying 100 V, using 10 cm by 10 cm electrodes, across the porous layer and then increasing the voltage applied across the porous layer until a current of 18 mA is produced. The applied voltage at which 18 mA or more of current is first measured is the breakdown voltage.

When a battery separator comprises two or more porous layers, each porous layer may independently have a breakdown voltage in one or more of the above-referenced ranges.

The porous layers described herein may have a variety of acid filling times. In some embodiments, a porous layer has an acid filling time of greater than or equal to 1 min, greater than or equal to 1.5 mins, greater than or equal to 2 mins, greater than or equal to 2.5 mins, greater than or equal to 3 mins, greater than or equal to 4 mins, greater than or equal to 5 mins, greater than or equal to 6 mins, greater than or equal to 8 mins, greater than or equal to 10 mins, greater than or equal to 12.5 mins, greater than or equal to 15 mins, greater than or equal to 17.5 mins, greater than or equal to 20 mins, greater than or equal to 22.5 mins, greater than or equal to 25 mins, or greater than or equal to 27.5 mins. In some embodiments, a porous layer has an acid filling time of less than or equal to 30 mins, less than or equal to 27.5 mins, less than or equal to 25 mins, less than or equal to 22.5 mins, less than or equal to 20 mins, less than or equal to 17.5 mins, less than or equal to 15 mins, less than or equal to 12.5 mins, less than or equal to 10 mins, less than or equal to 8 mins, less than or equal to 6 mins, less than or equal to 5 mins, less than or equal to 4 mins, less than or equal to 3 mins, less than or equal to 2.5 mins, less than or equal to 2 mins, or less than or equal to 1.5 mins. Combinations of the above-referenced ranges are also possible. Other ranges are also possible.

The acid filling time of a battery separator may be determined by the procedure described in this paragraph and the following paragraph. First, the battery separator may be prepared for measurement. This may comprise laminating the battery separator between two transparent poly(carbonate) plates. Then, pressure can be applied to the transparent poly(carbonate) plates to compress the separator such that the ratio of basis weight in gsm to thickness in mm is approximately 220. During these processes, a rubber gasket can be positioned between the two transparent poly(carbonate) plates such that it surrounds the battery separator laterally, and two plastic shims can be positioned between the rubber gasket and the battery separator.

After the above-described assembly process, the pressure in the space between the two transparent poly(carbonate) plates can be reduced to approximately 200 Torr by use of a vacuum pump in fluidic communication with a hole in one of the transparent poly(carbonate) plates positioned above the battery separator. Then, red-dyed 1.28 spg H₂SO₄ at atmospheric pressure can be introduced between the transparent poly(carbonate) plates through the same hole in the transparent poly(carbonate) plate. At certain points in time during this process, the red-dyed 1.28 spg H₂SO₄ can be removed from fluidic communication with the hole in the poly(carbonate) plate and this hole can instead be placed in fluidic communication with the vacuum pump for 5 seconds, after which it can again be placed in fluidic communication with the red-dyed 1.28 spg H₂SO₄. This application of vacuum may assist with the removal of air from the battery separator. The total amount of time from initial introduction of the red-dyed 1.28 spg H₂SO₄ to the space between the two transparent poly(carbonate) plates to the diffusion of this acid throughout the entire battery separator can be recorded as the acid filling time.

When a battery separator comprises two or more porous layers, each porous layer may independently have an acid filling time in one or more of the above-referenced ranges.

In some embodiments, a battery separator comprises one or more porous layers as described above and further comprises one or more further layers in addition to these porous layer or layers. Such layers may also be porous, but they may differ from the porous layers described above in one or more ways. Table 1 below lists some examples of further layers that may be included in the battery separators described herein and some of their exemplary properties. It should be understood that some battery separators may include a layer of a type listed below but have a value for one or more properties outside the ranges listed below (e.g., a basis weight higher or lower than the range of basis weights provided, a mean flow pore size higher or lower than the range of mean flow pore sizes provided, etc.). The properties listed below may be measured in the same manner as they would be for the porous layers described above.

TABLE 1

| | | | | Non-wet laid |
|---|---|---|---|---|
| | | | | non-woven fiber |
| | | | | web comprising |
| Layer type | Glass mat type 1 | Glass mat type 2 | Pasting paper | synthetic fibers |
| Fibers present | Microglass fibers | Chopped strand | Cellulose fibers | Monocomponent |
| (wt % of the total | (60-100) and/or | glass fibers | (0-95) and/or | synthetic fibers |
| fiber weight) | chopped strand | (70-90) and binder | microglass fibers | (100) |
| | glass fibers (0-40) | fibers (10-30) | (0-70), and/or | |
| | | | chopped strand | |
| | | | glass fibers (0-70) | |
| Basis weight | 50-600 | 5-300 | 0.1-300 | 15-100 |
| (gsm) | | | | |
| Porosity (%) | ≥75 | 50-95 | 5-98 | 5-98 |
| Tensile strength | 0.3-20 | 4-6 | 0.1-10 | 0.1-15 |
| in the machine | | | | |
| direction | | | | |
| (lbs/inch) | | | | |
| Thickness (mm) | 0.5-5 | 0.3-10 | 0.05-2 | 0.05-2 |

Additionally, further layers within a battery separator in addition to one or more porous layers as described above may be arranged as desired. For instance, a battery separator may comprise any of the above-described further layers in one or more of the following positions: an outermost layer in the battery separator (e.g., in a battery separator for which a plurality of ribs does not form one of the outermost layers), a layer directly adjacent to a plurality of ribs, and a layer that is both not an outermost layer and not directly adjacent to a plurality of ribs. Further layers may be positioned directly adjacent other further layers (e.g., of the same type, of different types), porous layers as described above, and/or a plurality of ribs.

In some embodiments, a battery separator comprises one or more additives. The additive(s) may enhance one or more properties of the battery separator in comparison to otherwise equivalent battery separators lacking the additive(s). The additive(s) may be positioned in a variety of different locations in the battery separator. For instance, a battery separator may comprise one or more additives positioned in a plurality of ribs, positioned in a porous layer, and/or positioned in a further layer. Further details regarding some additives that may be included in the battery separators described herein are provided below.

Additives may make up a variety of suitable amounts of the battery separators described herein. In some embodiments, one or more additives make up greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, or greater than or equal to 25 wt % of a battery separator. In some embodiments, one or more additives make up less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, or less than or equal to 0.0075 wt % of a battery separator. Combinations of the above-referenced ranges are also possible (e.g., greater than or equal to 0.005 wt % and less than or equal to 30 wt %, greater than or equal to 0.05 wt % and less than or equal to 20 wt %, or greater than or equal to 0.5 wt % and less than or equal to 10 wt %). Other ranges are also possible.

Each additive present in a battery separator may independently make up a wt % of the battery separator in one or more of the above-referenced ranges. Additionally, in some embodiments, all of the additives together in a battery separator may make up a wt % of the battery separator in one or more of the above-referenced ranges.

Additives may make up a variety of suitable amounts of one or more battery separator components described herein (e.g., pluralities of ribs, porous layers, further layers). In some embodiments, an additive makes up greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, or greater than or equal to 55 wt % of a battery separator component. In some embodiments, an additive makes up less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, less than or equal to 0.2 wt %, less than or equal to 0.1 wt %, or less than or equal to 0.075 wt % of a battery separator component. Combinations of the above-referenced ranges are also possible (e.g., greater than or equal to 0.05 wt % and less than or equal to 60 wt %, greater than or equal to 0.5 wt % and less than or equal to 40 wt %, or greater than or equal to 1 wt % and less than or equal to 20 wt %). Other ranges are also possible.

Each additive present in a battery separator component may independently make up a wt % of the battery separator component in one or more of the above-referenced ranges. Additionally, in some embodiments, all of the additives together in a battery separator component may make up a wt % of the battery separator component in one or more of the above-referenced ranges. When a battery separator comprises two or more components, each battery separator component may independently comprise one or more additives individually in an amount in one or more of the above-referenced ranges and/or may comprise a combination of additives that are present together in an amount in one or more of the above-referenced ranges.

In some embodiments, a battery separator comprises one or more conductive additives. Conductive additives may make up a variety of suitable amounts of the battery separators described herein. In some embodiments, one or more conductive additives make up greater than or equal to 0.002 wt %, greater than or equal to 0.005 wt %, greater than or equal to 0.0075 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 3.5 wt %, greater than or equal to 4 wt %, or greater than or equal to 4.5 wt % of a battery separator. In some embodiments, one or more conductive additives make up less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, less than or equal to 0.05 wt %, less than or equal to 0.02 wt %, less than or equal to 0.01 wt %, less than or equal to 0.0075 wt %, or less than or equal to 0.005 wt % of a battery separator. Combinations of the above-referenced ranges are also possible (e.g., greater than or equal to 0.002 wt % and less than or equal to 5 wt %, greater than or equal to 0.02 wt % and less than or equal to 4 wt %, or greater than or equal to 0.2 wt % and less than or equal to 3 wt %). Other ranges are also possible.

Each conductive additive present in a battery separator may independently make up a wt % of the battery separator in one or more of the above-referenced ranges. Additionally, in some embodiments, all of the conductive additives together in a battery separator may make up a wt % of the battery separator in one or more of the above-referenced ranges.

In some embodiments, a plurality of ribs comprises one or more conductive additives. Conductive additives may make up a variety of suitable amounts of the pluralities of ribs described herein. In some embodiments, one or more conductive additives make up greater than or equal to 0.004 wt %, greater than or equal to 0.008 wt %, greater than or equal to 0.02 wt %, greater than or equal to 0.04 wt %, greater than or equal to 0.08 wt %, greater than or equal to 0.2 wt %, greater than or equal to 0.4 wt %, greater than or equal to 0.6 wt %, greater than or equal to 0.8 wt %, greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % of the ribs in a plurality of ribs. In some embodiments, one or more conductive additives make up less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, less than or equal to 0.8 wt %, less than or equal to 0.6 wt %, less than or equal to 0.4 wt %, less than or equal to 0.2 wt %, less than or equal to 0.08 wt %, less than or equal to 0.04 wt %, less than or equal to 0.02 wt %, or less than or equal to 0.008 wt % of the ribs in a plurality of ribs. Combinations of the above-referenced ranges are also possible (e.g., greater than or equal to 0.004 wt % and less than or equal to 10 wt %, greater than or equal to 0.04 wt % and less than or equal to 8 wt %, or greater than or equal to 0.4 wt % and less than or equal to 6 wt %). Other ranges are also possible.

Each conductive additive present in a plurality of ribs may independently make up a wt % of the ribs in one or more of the above-referenced ranges. Additionally, in some embodiments, all of the conductive additives together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more conductive additives individually in an amount in one or more of the above-referenced ranges and/or may comprise a combination of conductive additives that are present together in an amount in one or more of the above-referenced ranges.

It is also possible for a battery separator to comprise a conductive coating (e.g., disposed on one or more components thereof). The conductive coating may comprise and/or be formed from one or more conductive additives.

Non-limiting examples of suitable conductive additives include carbon black, conductive polymers, carbon nanotubes, metallic particles, and metallic foil.

When a battery separator comprises two or more components comprising a conductive additive, each such component may independently comprise one or more conductive additives having one or more of the above-described compositions.

In some embodiments, a battery separator comprises one or more sulfation-reducing additives. Sulfation-reducing additives may make up a variety of suitable amounts of the battery separators described herein. In some embodiments, one or more sulfation-reducing additives make up greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, or greater than or equal to 17.5 wt % of a battery separator. In some embodiments, one or more sulfation-reducing additives make up less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, less than or equal to 0.1 wt %, or less than or equal to 0.075 wt % of a battery separator. Combinations of the above-referenced ranges are also possible (e.g., greater than or equal to 0.05 wt % and less than or equal to 20 wt %, greater than or equal to 0.5 wt % and less than or equal to 10 wt %, or greater than or equal to 1 wt % and less than or equal to 5 wt %). Other ranges are also possible.

Each sulfation-reducing additive present in a battery separator may independently make up a wt % of the battery separator in one or more of the above-referenced ranges. Additionally, in some embodiments, all of the sulfation-reducing additives together in a battery separator may make up a wt % of the battery separator in one or more of the above-referenced ranges.

In some embodiments, a plurality of ribs comprises one or more sulfation-reducing additives. Sulfation-reducing additives may make up a variety of suitable amounts of the pluralities of ribs described herein. In some embodiments, one or more sulfation-reducing additives make up greater than or equal to 0.1 wt %, greater than or equal to 0.2 wt %, greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, or greater than or equal to 35 wt % of the ribs in a plurality of ribs. In some embodiments, one or more sulfation-reducing additives make up less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, less than or equal to 1 wt %, less than or equal to 0.75 wt %, less than or equal to 0.5 wt %, or less than or equal to 0.2 wt % of the ribs in a plurality of ribs. Combinations of the above-referenced ranges are also possible (e.g., greater than or equal to 0.1 wt % and less than or equal to 40 wt %, greater than or equal to 1 wt % and less than or equal to 20 wt %, or greater than or equal to 2 wt % and less than or equal to 10 wt %). Other ranges are also possible.

Each sulfation-reducing additive present in a plurality of ribs may independently make up a wt % of the ribs in one or more of the above-referenced ranges. Additionally, in some embodiments, all of the sulfation-reducing additives together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more sulfation-reducing additives individually in an amount in one or more of the above-referenced ranges and/or may comprise a combination of sulfation-reducing additives that are present together in an amount in one or more of the above-referenced ranges.

Non-limiting examples of suitable sulfation-reducing additives include sulfate salts, such as alkali sulfate salts (e.g., sodium sulfate), alkaline earth sulfate salts (e.g., magnesium sulfate, calcium sulfate, barium sulfate), and transition metal sulfate salts (e.g., zinc sulfate). Some suitable sulfate salts may comprise a monovalent cation and some suitable sulfate salts may comprise a divalent cation.

When a battery separator comprises two or more components comprising a sulfation-reducing additive, each such component may independently comprise one or more sulfation-reducing additives having one or more of the above-described compositions.

In some embodiments, a battery separator comprises one or more antimony-suppression additives. Antimony-suppression additives may make up a variety of suitable amounts of the battery separators described herein. In some embodiments, one or more antimony-suppression additives make up greater than or equal to 0.5 wt %, greater than or equal to 0.75 wt %, greater than or equal to 1 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, or greater than or equal to 17.5 wt % of the battery separator. In some embodiments, one or more antimony-suppression additives make up less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2.5 wt %, less than or equal to 2 wt %, less than or equal to 1.5 wt %, or less than or equal to 0.75 wt % of the battery separator. Combinations of the above-referenced ranges are also possible (e.g., greater than or equal to 0.5 wt % and less than or equal to 20 wt %, greater than or equal to 1 wt % and less than or equal to 15 wt %, or greater than or equal to 2 wt % and less than or equal to 10 wt %). Other ranges are also possible.

Each antimony-suppression additive present in a battery separator may independently make up a wt % of the battery separator in one or more of the above-referenced ranges. Additionally, in some embodiments, all of the antimony-suppression additives together in a battery separator may make up a wt % of the battery separator in one or more of the above-referenced ranges.

In some embodiments, a plurality of ribs comprises one or more antimony-suppression additives. Antimony-suppression additives may make up a variety of suitable amounts of the pluralities of ribs described herein. In some embodiments, one or more antimony-suppression additives make up greater than or equal to 1 wt %, greater than or equal to 1.5 wt %, greater than or equal to 2 wt %, greater than or equal to 3 wt %, greater than or equal to 4 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, greater than or equal to 35 wt %, greater than or equal to 40 wt %, or greater than or equal to 45 wt % of the ribs in a plurality of ribs. In some embodiments, one or more antimony-suppression additives make up less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 4 wt %, less than or equal to 3 wt %, less than or equal to 2 wt %, or less than or equal to 1.5 wt % of the ribs in a plurality of ribs. Combinations of the above-referenced ranges are also possible (e.g., greater than or equal to 1 wt % and less than or equal to 50 wt %, greater than or equal to 2 wt % and less than or equal to 40 wt %, or greater than or equal to 4 wt % and less than or equal to 20 wt %). Other ranges are also possible.

Each antimony-suppression additive present in a plurality of ribs may independently make up a wt % of the ribs in one or more of the above-referenced ranges. Additionally, in some embodiments, all of the antimony-suppression additives together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more antimony-suppression additives individually in an amount in one or more of the above-referenced ranges and/or may comprise a combination of antimony-suppression additives that are present together in an amount in one or more of the above-referenced ranges.

Non-limiting examples of antimony-suppression additives include fluorocarbons, vinyl aldehydes, ketones, alkyl phosphonates, and natural rubber. The antimony-suppression additives may be particulate (e.g., in the form of a latex, a powder, and/or micronized particles). Particulate antimony-suppression additives may be introduced into a plurality of ribs from a suspension or other fluid comprising the particles (e.g., the suspension or other fluid may be mixed with one or more further materials to form a fluid from which the plurality of ribs may be formed).

In some embodiments, a battery separator comprises one or more water loss-reducing additives. Water loss-reducing additives may make up a variety of suitable amounts of the battery separators described herein. In some embodiments, one or more water loss-reducing additives make up greater than or equal to 0.025 wt %, greater than or equal to 0.05 wt %, greater than or equal to 0.075 wt %, greater than or equal to 0.1 wt %, greater than or equal to 0.2 wt %, greater than or equal to 0.5 wt %, greater than or equal to 0.75 wt %, greater than or equal to 1 wt %, greater than or equal to 1.5 wt %, greater than or equal to 2 wt %, greater than or equal to 3 wt %, greater than or equal to 4 wt %, greater than or equal to 5 wt %, greater than or equal to 6 wt %, or greater than or equal to 7.5 wt % of a battery separator. In some embodiments, one or more water loss-reducing additives make up less than or equal to 10 wt %, less than or equal to 7.5 wt %, less than or equal to 6 wt %, less than or equal to 5 wt %, less than or equal to 4 wt %, less than or equal to 3 wt %, less than or equal to 2 wt %, less than or equal to 1.5 wt %, less than or equal to 1 wt %, less than or equal to 0.75 wt %, less than or equal to 0.5 wt %, less than or equal to 0.2 wt %, less than or equal to 0.1 wt %, less than or equal to 0.075 wt %, or less than or equal to 0.05 wt % of a battery separator. Combinations of the above-referenced ranges are also possible (e.g., greater than or equal to 0.025 wt % and less than or equal to 10 wt %, greater than or equal to 0.05 wt % and less than or equal to 7.5 wt %, or greater than or equal to 1 wt % and less than or equal to 5 wt %). Other ranges are also possible.

Each water loss-reducing additive present in a battery separator may independently make up a wt % of the battery separator in one or more of the above-referenced ranges. Additionally, in some embodiments, all of the water loss-reducing additives together in a battery separator may make up a wt % of the battery separator in one or more of the above-referenced ranges.

In some embodiments, a plurality of ribs comprises one or more water loss-reducing additives. Water loss-reducing additives may make up a variety of suitable amounts of the pluralities of ribs described herein. In some embodiments, one or more water loss-reducing additives make up greater than or equal to 0.5 wt %, greater than or equal to 0.75 wt %, greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, or greater than or equal to 20 wt %, greater than or equal to 22.5 wt % of the ribs in a plurality of ribs. In some embodiments, one or more water loss-reducing additives make up less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 2 wt %, less than or equal to 1 wt %, or less than or equal to 0.75 wt % of the ribs in a plurality of ribs. Combinations of the above-referenced ranges are also possible (e.g., greater than or equal to 0.5 wt % and less than or equal to 25 wt %, greater than or equal to 1 wt % and less than or equal to 20 wt %, or greater than or equal to 2 wt % and less than or equal to 10 wt %). Other ranges are also possible.

Each water loss-reducing additive present in a plurality of ribs may independently make up a wt % of the ribs in one or more of the above-referenced ranges. Additionally, in some embodiments, all of the water loss-reducing additives together in a plurality of ribs may make up a wt % of the ribs in one or more of the above-referenced ranges. When a battery separator comprises two pluralities of ribs (e.g., disposed on opposite external surfaces), each plurality of ribs may independently comprise one or more water loss-reducing additives individually in an amount in one or more of the above-referenced ranges and/or may comprise a combination of water loss-reducing additives that are present together in an amount in one or more of the above-referenced ranges.

Non-limiting examples of suitable water loss-reducing additives include sulfate salts (e.g., zinc sulfate, alkyl ammonium hydrogen sulfate) and benzylideneacetone.

Additives may be introduced into the battery separators described herein (and/or one or more of their components and/or layers) in a variety of suitable manners. For instance, additives may be introduced into battery separators and/or battery separator components by vapor deposition onto an already-fabricated battery separator and/or battery separator component, addition of a foil to an already-fabricated battery separator and/or battery separator component, and/or inclusion in a composition from which a battery separator and/or battery separator is formed (e.g., a fluid from which a plurality of ribs are formed, a furnish or other composition from which a porous layer is formed).

The battery separators described herein may have a variety of lifetimes. In some embodiments, a battery separator has a lifetime of greater than or equal to 50 hours, greater than or equal to 75 hours, greater than or equal to 100 hours, greater than or equal to 150 hours, greater than or equal to 200 hours, greater than or equal to 300 hours, greater than or equal to 400 hours, greater than or equal to 500 hours, greater than or equal to 600 hours, greater than or equal to 800 hours, greater than or equal to 1000 hours, greater than or equal to 1250 hours, greater than or equal to 1500 hours, or greater than or equal to 1750 hours. In some embodiments, a battery separator has a lifetime of less than or equal to 2000 hours, less than or equal to 1750 hours, less than or equal to 1500 hours, less than or equal to 1250 hours, less than or equal to 1000 hours, less than or equal to 800 hours, less than or equal to 600 hours, less than or equal to 500 hours, less than or equal to 400 hours, less than or equal to 300 hours, less than or equal to 200 hours, less than or equal to 150 hours, less than or equal to 100 hours, or less than or equal to 75 hours. Combinations of the above-referenced ranges are also possible (e.g., greater than or equal to 50 hours and less than or equal to 2000 hours, greater than or equal to 100 hours and less than or equal to 1000 hours, or greater than or equal to 200 hours and less than or equal to 800 hours). Other ranges are also possible.

The lifetime of a battery separator may be determined in accordance with IS 6071-1986. This test comprises exposing the battery separator to overcharging conditions until the voltage drop across the battery separator is 0 V. Overcharging the battery causes oxygen to be evolved at the positive electrode, which causes the electrolyte to become oxidative. As the electrolyte becomes oxidative, the battery separator degrades and its electrical resistivity decreases. This causes the voltage drop across the battery separator to decrease. When the measured voltage drop across the battery separator is 0 V, it presents appreciably no resistance to current flow. The lifetime is the time elapsed between the beginning of the exposure of the battery separator to the overcharging conditions and the moment when the voltage drop across the porous layer is 0 V.

In some embodiments, a battery separator described herein is positioned in a lead-acid battery. Additionally, some embodiments relate to lead-acid batteries comprising the separators described herein. Lead-acid batteries typically comprise a first battery plate (e.g., a negative battery plate) that comprises lead and a second battery plate (e.g., a positive battery plate) that comprises lead dioxide. During discharge, electrons pass from the first battery plate to the second battery plate while the lead paste in the first battery plate is oxidized to form lead sulfate and the lead dioxide in the second battery plate is reduced to also form lead sulfate. During charge, electrons pass from the second battery plate to the first battery plate while the lead sulfate in the first battery plate is reduced to form lead and the lead sulfate in the second battery plate is oxidized to form lead dioxide.

In some embodiments, a battery separator described herein may be configured for use with a flooded battery. For instance, some battery separators may be suitable for use in conventional flooded batteries (and/or may be present in a conventional flooded batteries) and/or may be suitable for use in enhanced flooded batteries (EFBs) (and/or may be present EFB batteries). In some embodiments, a flooded battery is unsealed and exhausts gases produced therein (e.g., during discharge, during charge) to the environment surrounding the battery through one or more vents therein. These vents may, additionally or alternatively, allow acid, steam, condensation, and/or other species to flow into and/or out of the flooded battery.

It is also possible for a battery separator described herein to be configured for use in a valve regulated lead-acid battery (VRLA) battery, such as an AGM/VRLA battery (and/or to be present in a VRLA battery such as an AGM/VRLA battery), or to be configured for use in a VRLA/Gel battery (and/or may be present in a VRLA/Gel battery). VRLA batteries are lead-acid batteries that comprise a valve configured to vent one or more gases from the battery. These gases may include gases that form as a result of electrolyte decomposition during overcharging, such as hydrogen gas and/or oxygen gas. It may be desirable to maintain the gases in the battery so that they may recombine, reducing or eliminating the need to replenish the decomposed electrolyte. However, it may also be desirable to maintain the pressure inside the battery at a safe level. For these reasons, the valve may be configured to vent the gas(es) under some circumstances, such as when the pressure inside the battery is above a threshold value, but not in others, such as when the pressure inside the battery is below the threshold value.

Battery plates typically comprise a battery paste disposed on a grid. A battery paste included in a negative battery plate may comprise lead, and/or may comprise both lead and lead dioxide (e.g., prior to full charging, during fabrication, battery assembly, and/or during one or more portions of a method described herein). A battery paste included in a positive battery plate may comprise lead dioxide, and/or may comprise both lead and lead dioxide (e.g., prior to full charging, during fabrication, during battery assembly, and/or during one or more portions of a method described herein). Grids may be included in the battery plates described herein and, in some embodiments, may include lead and/or a lead alloy.

In some embodiments, one or more battery plates may further comprise one or more additional components. For instance, a battery plate may comprise a reinforcing material, such as an expander. When present, an expander may comprise barium sulfate, carbon black and lignin sulfonate as the primary components. The components of the expander(s) (e.g., carbon black and/or lignin sulfonate, if present, and/or any other components) can be pre-mixed or not pre-mixed. In some embodiments, a battery plate may comprise a commercially available expander, such as an expander produced by Hammond Lead Products (Hammond, IN) (e.g., a Texex® expander) or an expander produced by Atomized Products Group, Inc. (Garland, TX). Further examples of reinforcing materials include chopped organic fibers (e.g., having an average length of 0.125 inch or more), chopped glass fibers, metal sulfate(s) (e.g., nickel sulfate, copper sulfate), red lead (e.g., a Pb₃O₄-containing material), litharge, and paraffin oil.

It should be understood that while the additional components described above may be present in any combination of battery plates in a battery (e.g., in a negative battery plate and a positive battery plate, in a negative battery plate but not a positive battery plate, in a positive battery plate but not a negative battery plate, in no battery plates), some additional components may be especially advantageous for some types of battery plates. For instance, expanders, metal sulfates, and paraffins may be especially advantageous for use in positive battery plates. One or more of these components may be present in a positive battery plate, and absent in a negative battery plate. Some additional components described above may have utility in many types of battery plates (e.g., negative battery plates, positive battery plates). Non-limiting examples of such components include fibers (e.g., chopped organic fibers, chopped glass fibers). These components may, in some embodiments, be present in both negative and positive battery plates.

As described elsewhere herein, some embodiments relate to methods of fabricating battery separators. Such methods may comprise passing a fluid comprising a polymer through a screen comprising a plurality of orifices onto a porous layer. After this step, the fluid may be cooled to form a plurality of ribs comprising the polymer that are disposed on the porous layer. Further details regarding this method are provided below.

The screens employed in the methods described herein may be formed from one or more metals and/or alloys, such as nickel, stainless steel, copper, and/or aluminum. The orifices may be formed therein by a variety of suitable techniques, non-limiting examples of which include mechanical cutting, electroplating, electroforming, and laser cutting. The orifices may have a variety of suitable shapes, such as the same shapes as those described above with respect to the cross-sections of the ribs (e.g., circular, oval, diamond, rectangular, square, line segment, star). Similarly, the orifices may have one or more of the symmetries described above with respect to the ribs (e.g., rectangular, tetragonal, hexagonal) and/or have one or more of the periodicities described above with respect to the ribs (e.g., sinusoidal, waved).

As described elsewhere herein, in some embodiments, a porous layer is translated beneath a screen comprising a plurality of orifices. The speed at which the porous layer is translated may be greater than or equal to 1 m/min, greater than or equal to 2 m/min, greater than or equal to 5 m/min, greater than or equal to 7.5 m/min, greater than or equal to 10 m/min, greater than or equal to 12.5 m/min, greater than or equal to 15 m/min, greater than or equal to 17.5 m/min, greater than or equal to 20 m/min, greater than or equal to 22.5 m/min, greater than or equal to 25 m/min, or greater than or equal to 27.5 m/min. The speed at which the porous layer is translated may be less than or equal to 30 m/min, less than or equal to 27.5 m/min, less than or equal to 25 m/min, less than or equal to 22.5 m/min, less than or equal to 20 m/min, less than or equal to 17.5 m/min, less than or equal to 15 m/min, less than or equal to 12.5 m/min, less than or equal to 10 m/min, less than or equal to 7.5 m/min, less than or equal to 5 m/min, or less than or equal to 2 m/min. Combinations of the above-referenced ranges are also possible (e.g., greater than or equal to 1 m/min and less than or equal to 30 m/min). Other ranges are also possible.

As described elsewhere herein, in some embodiments, a hollow screen comprising a plurality of orifices is rotated. The speed at which the screen is rotated may have a value such that the speed of the outer surface of the screen is greater than or equal to 1 m/min, greater than or equal to 2 m/min, greater than or equal to 5 m/min, greater than or equal to 7.5 m/min, greater than or equal to 10 m/min, greater than or equal to 12.5 m/min, greater than or equal to 15 m/min, greater than or equal to 17.5 m/min, greater than or equal to 20 m/min, greater than or equal to 22.5 m/min, greater than or equal to 25 m/min, greater than or equal to 27.5 m/min, greater than or equal to 30 m/min, greater than or equal to 40 m/min, greater than or equal to 50 m/min, greater than or equal to 75 m/min, greater than or equal to 100 m/min, greater than or equal to 150 m/min, or greater than or equal to 200 m/min. The speed at which the screen is rotated may have a value such that the speed of the outer surface of the screen is less than or equal to 300 m/min, less than or equal to 200 m/min, less than or equal to 150 m/min, less than or equal to 100 m/min, less than or equal to 75 m/min, less than or equal to 50 m/min, less than or equal to 40 m/min, less than or equal to 30 m/min, less than or equal to 27.5 m/min, less than or equal to 25 m/min, less than or equal to 22.5 m/min, less than or equal to 20 m/min, less than or equal to 17.5 m/min, less than or equal to 15 m/min, less than or equal to 12.5 m/min, less than or equal to 10 m/min, less than or equal to 7.5 m/min, less than or equal to 5 m/min, or less than or equal to 2 m/min. Combinations of the above-referenced ranges are also possible (e.g., greater than or equal to 1 m/min and less than or equal to 300 m/min, or greater than or equal to 1 m/min and less than or equal to 30 m/min). Other ranges are also possible.

Fluid passing through a plurality of orifices may do so at a variety of suitable temperatures. In some embodiments, a fluid passing through a plurality of orifices is at a temperature of greater than or equal to 25° C., greater than or equal to 27.5° C., greater than or equal to 30° C., greater than or equal to 32.5° C., greater than or equal to 35° C., or greater than or equal to 37.5° C. In some embodiments, a fluid passing through a plurality of orifices is at a temperature of less than or equal to 40° C., less than or equal to 37.5° C., less than or equal to 35° C., less than or equal to 32.5° C., less than or equal to 30° C., or less than or equal to 27.5° C. Combinations of the above-referenced ranges are also possible (e.g., greater than or equal to 25° C. and less than or equal to 40° C.). Other ranges are also possible.

In some embodiments, a fluid that has passed through a plurality of orifices undergoes a curing process. The curing process may comprise exposing the fluid to an environment having an elevated temperature (e.g., 160° C.).

Some embodiments comprise cooling a fluid after passing it through a plurality of orifices and/or after performing a curing process. The fluid may be cooled by exposing it to an environment having a reduced temperature. The temperature of the environment may be less than or equal to 40° C., less than or equal to 35° C., less than or equal to 30° C., less than or equal to 25° C., less than or equal to 20° C., less than or equal to 15° C., or less than or equal to 10° C. The temperature of the environment may be greater than or equal to 5° C., greater than or equal to 10° C., greater than or equal to 15° C., greater than or equal to 20° C., greater than or equal to 25° C., greater than or equal to 30° C., or greater than or equal to 35° C. Combinations of the above-referenced ranges are also possible (e.g., less than or equal to 40° C. and greater than or equal to 5° C.). Other ranges are also possible.

Then step of cooling a fluid to form a plurality of ribs may be followed by one or more subsequent steps. For instance, after the plurality of ribs are formed, the resultant battery separator may be dried in an oven, cooled in a cooling chamber (e.g., subsequently to being dried in the oven), and/or wound onto rolls. It is also possible for the porous layer and the ribs disposed thereon to be manipulated (e.g., cut, bent, laminated) to have a desired macroscopic morphology.

In some embodiments, a porous layer is fabricated by a wet laying process. In general, a wet laying process involves mixing together fibers of one or more type; for example, a plurality of glass fibers may be mixed together on its own or with a plurality of monocomponent synthetic fibers and/or a plurality of multicomponent fibers to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container, a plurality of monocomponent synthetic fibers may be mixed and pulped in a second container, and a plurality of multicomponent synthetic fibers may be mixed and pulped in a third container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives, filler). Furthermore, it should be appreciated that other combinations of fibers types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer.

In some embodiments, multiple porous layers may be formed simultaneously or sequentially in a wet laying process. For instance, a first porous layer may be formed as described above, and then one or more porous layers may be formed on the first porous layer by following the same procedure. As an example, a dispersion in a solvent or slurry may be applied to a first porous layer on a wire conveyor, and vacuum applied to the dispersion or slurry to form a second porous layer on the first porous layer. Further layers may be formed on the first porous layer and the second porous layer by following this same process.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A porous layer can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the fiber slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

### Example 1

This Example describes the characterization of the thermal and chemical stabilities of ribs of different types disposed on battery separators.

A first type of ribs was formed by passing a fluid through a screen onto a porous layer, curing the fluid, and then cooling the fluid. A second type of ribs was formed by performing hot melt deposition of a polymer onto an equivalent porous layer.

Portions of the resultant battery separators were exposed to 360° C. heat for up to 6 seconds. As can be seen from FIG. 6, the ribs formed by the first process showed a higher level of stability upon such exposure than the ribs formed by the second process. In FIG. 6, the upper row shows micrographs of the battery separator formed by the first process at various time points and the lower row shows micrographs of the battery separator formed by the second process at these same time points. The ribs formed by the first process were structurally stable throughout the 6 second testing period, while the ribs formed by the second process began to soften after 2 seconds of exposure to 360° C., with complete deformation occurring by 6 seconds of such exposure.

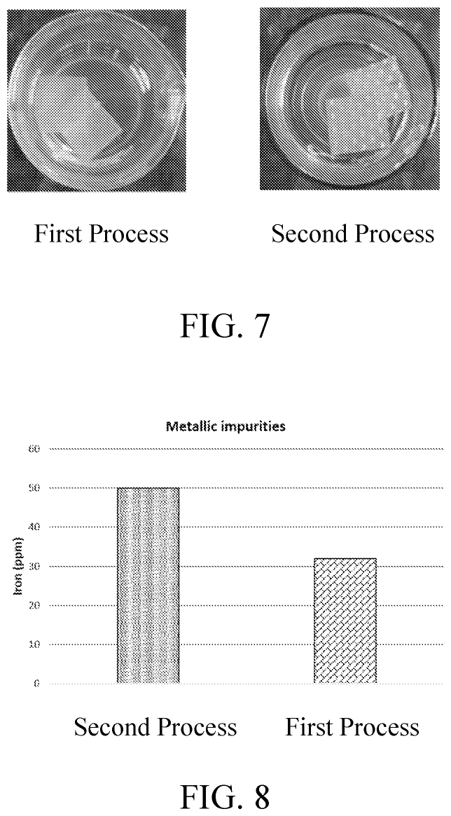

Different portions of the resultant battery separators that were not exposed to 360° C. heat were soaked in 98% sulfuric acid for one day at room temperature. After this soaking, both battery separators were assessed to determine the amount of iron leached therefrom and were subject to electrochemical compatibility tests. As can be seen in FIG. 7, both types of ribs were structurally stable after the sulfuric acid treatment. The electrochemical compatibility tests also indicated that both types of ribs exhibited sufficient chemical stability to be suitable for use in lead-acid batteries. However, the ribs formed by the first process leached less iron into the sulfuric acid than the ribs formed by the second process (see FIG. 8, which shows the amount of iron leached into the electrolyte from each plurality of ribs). It is thus believed that the presence of the filler in the ribs reduced the tendency of iron to leach into sulfuric acid.

### Example 2

This Example describes selected properties of battery separators having various designs.

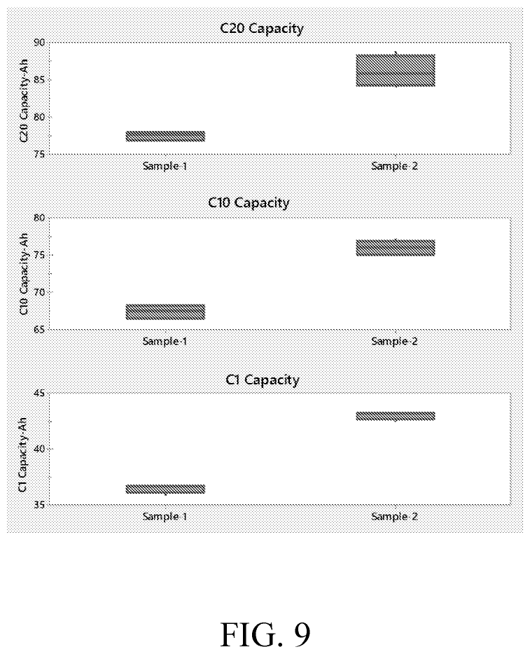

Each battery separator included a plurality of ribs, a porous layer, and a non-woven fiber web for which glass fibers made up 100 wt % of the fibers. The porous layer was positioned between the ribs and the non-woven fiber web. Each battery separator was then positioned in a battery, and these batteries were subsequently evaluated based on IEC60095:2006-11 to determine their C20, C10, and C1 capacities (their capacities when discharged over 20 hours, 10 hours, and 1 hour, respectively). Table 2 below summarizes several properties of these battery separators. FIG. 9 shows the C20, C10, and C1 capacities for the batteries in which they were positioned. As can be seen from FIG. 9, battery separators comprising ribs including filler had higher capacities than similar battery separators comprising ribs lacking filler.

TABLE 2

| Sample No. | 1 | 2 |
|---|---|---|
| Battery separator type | Battery separator | Battery separator |
| | comprising continuous | comprising discontinuous |
| | ribs lacking filler | ribs having a circular |
| | | cross-section and |
| | | including filler |
| Battery separator | 1.37 | 1.42 |
| thickness (mm) | | |
| Porous layer thickness | 0.43 | 0.44 |
| (mm) | | |
| Rib height (mm) | 0.52 | 0.53 |
| Rib spacing (mm) | 25 | 4 |
| Non-woven fiber web | 0.4 | 0.57 |
| thickness (mm) | | |
| Battery separator | 49 | 65 |
| volume porosity (%) | | |

### Example 3

This Example compares the electrical resistances of battery separators comprising ribs having varying porosities.

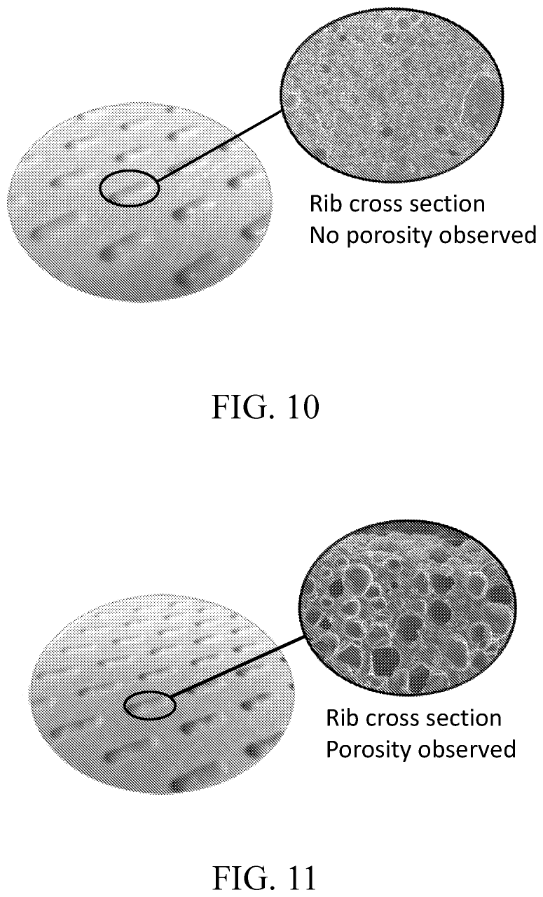

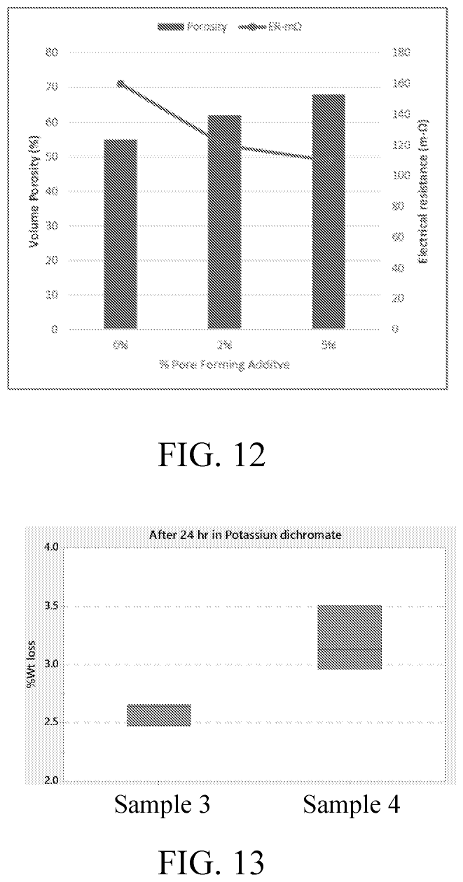

The ribs were fabricated by passing a fluid through a screen onto a porous layer. The fluid comprised a polymer and a pore forming additive. FIG. 10 shows a micrograph of the battery separator comprising ribs having 0% porosity and FIG. 11 shows a micrograph of the battery separator comprising ribs having 50% porosity. FIG. 12 shows the porosity of the battery separators as a function of the amount of pore-forming additive present in the fluid. In FIG. 12, the percentage values for the amount of pore-forming additive refer to its weight percent in the fluid from which the ribs are formed. As can be seen from FIG. 12, increasing the amount of pore-forming additive in this fluid increases the porosity of the ribs and thus the porosity of the battery separator as a whole. Additionally, the increasing porosity of the battery separator correlates with a decreasing electrical resistance thereof.

### Example 4

This Example compares the weight loss for two battery separators under two distinct conditions: upon exposure to potassium dichromate in the presence of sulfuric acid, and upon exposure to hydrogen peroxide in the presence of sulfuric acid. Each of these species is an oxidizer that is present in lead acid batteries during operation, and so the separator's resistance to degradation upon exposure to such species is informative regarding its resistance to degradation upon exposure to the oxidizing conditions present in lead-sulfate batteries during operation.

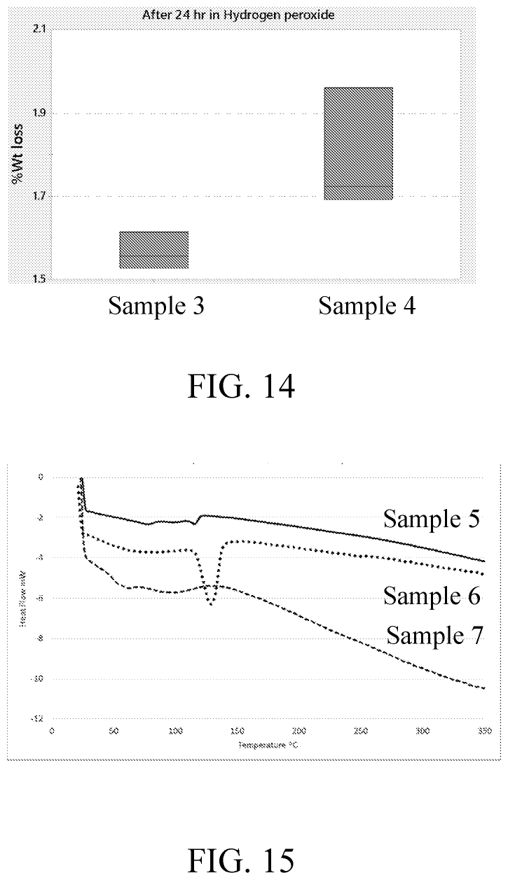

Each battery separator was, in accordance with BCIS-03B (2015), exposed to the relevant species by immersing it in a fluid comprising the relevant species and sulfuric acid having a specific gravity of 1.260 for 24 hours. Then, the battery separators were removed from that fluid, dried at 50° C. for four hours, and then rinsed in water until the rinsate had a pH of 7. The battery separators were weighed before and after the above-described processes in order to determine their weight losses during these processes. Table 3, below, summarizes the different samples and FIGS. 13 and 14 show, respectively, the weight loss for each battery separator upon exposure to potassium chromate and hydrogen peroxide. As can be seen from these FIGs., the battery separator comprising ribs including filler exhibited less weight loss in both conditions than the extruded polyethylene separator. Therefore, such battery separators are likely to undergo less damage in the presence of the corrosive conditions present during lead-acid battery operation.

TABLE 3

| Sample No. | 3 | 4 |
|---|---|---|
| Battery separator | Battery separator comprising | Extruded |
| type | discontinuous ribs | polyethylene |
| | comprising filler | separator |

### Example 5

This Example compares the weight loss for three different rib materials upon exposure to heat.

Each rib material was analyzed using differential scanning calorimetry. This analysis was performed in the presence of a nitrogen atmosphere and at a ramp rate of 10° C./min. Table 4, below, summarizes the different samples and FIG. 15 shows the heat flow for each sample. As can be seen from FIG. 15, the rib material comprising filler required less heat flow than the other two samples. As heat flow during differential scanning calorimetry is indicative of thermal degradation, the rib material comprising filler was accordingly more thermally stable than the other two samples.

TABLE 4

| Sample No. | 6 | 7 | 8 |
|---|---|---|---|
| Rib Material | Polymeric ribs | Polymeric ribs | Ribs from extruded |
| | comprising filler | lacking filler | polyethylene |
| | | | separator |

### Example 6

This Example compares the performance of battery separators having different average rib spacings.

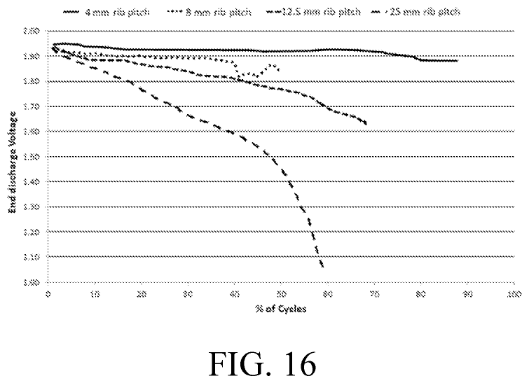

Battery separators were fabricated comprising pluralities of ribs having average spacings (i.e., pitches) of 4 mm, 8 mm, 12.5 mm, and 25 mm. These battery separators were otherwise equivalent to each other. The battery separators were positioned in lead-acid batteries that were cycled to a 50% depth of discharge at a charge factor of 1.15. FIG. 16 shows the end of discharge voltage as a function of the number of cycles performed for each of these batteries. As can be seen from FIG. 16, the batteries comprising battery separators having ribs that were more closely spaced performed better than battery separators having ribs that were less closely spaced.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A battery separator, comprising:
a porous layer; and
a plurality of ribs disposed on the porous layer, wherein:
the ribs comprise a polymer,
the ribs comprise a filler, and
the plurality of ribs forms a discrete component of the battery separator.

2. A battery separator, comprising:
a porous layer; and
a plurality of ribs disposed on the porous layer, wherein:
the ribs exhibit a mass loss of less than or equal to 2% upon exposure to a temperature of 160° C. for 13 minutes, and
the plurality of ribs forms a discrete component of the battery separator.

3. A battery separator, comprising:
a porous layer; and
a plurality of ribs disposed on the porous layer, wherein:
the ribs are porous, and
the plurality of ribs forms a discrete component of the battery separator.

4. A method for fabricating a battery separator, comprising:
passing a fluid comprising a polymer through a screen comprising a plurality of orifices onto a porous layer; and
cooling the fluid to form ribs comprising the polymer disposed on the porous layer.

5. A battery separator or method as in any preceding claim, wherein the ribs comprise a polymer.

6. A battery separator or method as in any preceding claim, wherein the ribs comprise two or more polymers.

7. A battery separator or method as in any preceding claim, wherein the polymer(s) comprise a homopolymer, a copolymer, and/or a terpolymer.

8. A battery separator or method as in any preceding claim, wherein the polymer(s) comprise a polymer that is amorphous.

9. A battery separator or method as in any preceding claim, wherein the polymer(s) comprise a poly(acrylate), a poly(styrene)-poly(acrylate) copolymer, a poly(ester), and/or a poly(alpha olefin).

10. A battery separator or method as in any preceding claim, wherein the polymer(s) comprise a polymer having a degree of polymerization of greater than or equal to 500 and less than or equal to 10000.

11. A battery separator or method as in any preceding claim, wherein the polymer(s) make up greater than or equal to 10 wt % and less than or equal to 90 wt % of the ribs.

12. A battery separator or method as in any preceding claim, wherein the ribs comprise a plasticizer.

13. A battery separator or method as in any preceding claim, wherein the ribs comprise two or more plasticizers.

14. A battery separator or method as in any preceding claim, wherein the plasticizer(s) comprise a non-volatile, organic compound.

15. A battery separator or method as in any preceding claim, wherein the plasticizer(s) comprise a sulfate of an alkylsulfite acid, an ester of an alkylsulfite acid, an alcohol, a phenol, a diester of an ortho-phthalic acid, and/or an epoxy ester of an unsaturated fatty acid.

16. A battery separator or method as in any preceding claim, wherein the diester of the ortho-phthalic acid is a reaction product of a phthalic anhydride.

17. A battery separator or method as in any preceding claim, wherein the diester of the ortho-phthalic acid is a reaction product of an oxo alcohol.

18. A battery separator or method as in any preceding claim, wherein the oxo alcohol comprises greater than or equal to 4 and less than or equal to 13 carbon atoms.

19. A battery separator or method as in any preceding claim, wherein the epoxy ester of the unsaturated fatty acid is plant-derived.

20. A battery separator or method as in any preceding claim, wherein the epoxy ester of the unsaturated fatty acid comprises an epoxidized butyl ester of an unsaturated fatty acid and/or an epoxidized n-hexyl ester of an unsaturated fatty acid.

21. A battery separator or method as in any preceding claim, wherein the plasticizer(s) make up greater than or equal to 10 wt % and less than or equal to 60 wt % of the ribs.

22. A battery separator or method as in any preceding claim, wherein the ribs comprise a filler.

23. A battery separator or method as in any preceding claim, wherein the ribs comprise two or more fillers.

24. A battery separator or method as in any preceding claim, wherein the filler(s) comprise a filler that is chemically inert.

25. A battery separator or method as in any preceding claim, wherein the filler(s) comprise a filler that has a surface area of greater than or equal to 20 m²/g and less than or equal to 950 m²/g.

26. A battery separator or method as in any preceding claim, wherein the filler(s) comprise a filler that has a pore volume of greater than or equal to 0.2 cm³/g.

27. A battery separator or method as in any preceding claim, wherein the filler(s) comprise a filler that has an average diameter of greater than or equal to 0.01 micron and less than or equal to 75 microns.

28. A battery separator or method as in any preceding claim, wherein the filler(s) make up greater than or equal to 1 wt % and less than or equal to 90 wt % of the ribs.

29. A battery separator or method as in any preceding claim, wherein, upon exposure to a leaching solution, less than or equal to 30 ppm of iron is leached from the ribs.

30. A battery separator or method as in any preceding claim, wherein an average spacing between the ribs is greater than or equal to 2 mm and less than or equal to 25 mm.

31. A battery separator or method as in any preceding claim, wherein an average spacing between the ribs is greater than or equal to 0.1 mm and less than or equal to 12.5 mm.

32. A battery separator or method as in any preceding claim, wherein an average width of the ribs is greater than or equal to 0.5 mm and less than or equal to 5 mm.

33. A battery separator or method as in any preceding claim, wherein an average width of the ribs is greater than or equal to 0.05 mm and less than or equal to 2.5 mm.

34. A battery separator or method as in any preceding claim, wherein the ribs have an average height of greater than or equal to 0.1 mm and less than or equal to 3 mm.

35. A battery separator or method as in any preceding claim, wherein the plurality of ribs comprises ribs having a cross-section in a plane parallel to the porous layer that is circular.

36. A battery separator or method as in any preceding claim, wherein the plurality of ribs comprises ribs having a cross-section in a plane parallel to the porous layer that is oval.

37. A battery separator or method as in any preceding claim, wherein the plurality of ribs comprises ribs having a cross-section in a plane parallel to the porous layer that is diamond-shaped.

38. A battery separator or method as in any preceding claim, wherein the plurality of ribs comprises ribs having a cross-section in a plane parallel to the porous layer that has a line segment shape.

39. A battery separator or method as in any preceding claim, wherein the plurality of ribs comprises continuous ribs.

40. A battery separator or method as in any preceding claim, wherein the plurality of ribs comprises discontinuous ribs.

41. A battery separator or method as in any preceding claim, wherein the ribs form a pattern that has hexagonal symmetry.

42. A battery separator or method as in any preceding claim, wherein the ribs comprise a waved structure.

43. A battery separator or method as in any preceding claim, wherein the ribs comprise a sinusoidal structure.

44. A battery separator or method as in any preceding claim, wherein a porosity of the ribs is greater than or equal to 0% and less than or equal to 90%.

45. A battery separator or method as in any preceding claim, wherein the battery separator comprises two or more porous layers.

46. A battery separator or method as in any preceding claim, wherein the battery separator comprises a porous layer that is fibrous.

47. A battery separator or method as in any preceding claim, wherein the battery separator comprises a porous layer that is a non-woven fiber web.

48. A battery separator or method as in any preceding claim, wherein the non-woven fiber web is a wet laid non-woven fiber web, or a non-wet laid non-woven fiber web.

49. A battery separator or method as in any preceding claim, wherein the battery separator comprises a porous layer that is an extruded layer, a sintered layer, a woven layer, a knitted layer, a braided layer, and/or a membrane.

50. A battery separator or method as in any preceding claim, wherein a thickness of the porous layer is greater than or equal to 0.05 mm and less than or equal to 6 mm.

51. A battery separator or method as in any preceding claim, wherein a volume porosity of the porous layer is greater than or equal to 0% and less than or equal to 98%.

52. A battery separator or method as in any preceding claim, wherein the battery separator further comprises a glass mat, a pasting paper, and/or a fabric layer.

53. A battery separator or method as in any preceding claim, wherein an electrical resistance of the porous layer is greater than or equal to 5 mΩ·cm² and less than or equal to 800 mΩ·cm².

54. A battery separator or method as in any preceding claim, wherein the battery separator comprises a conductive additive.

55. A battery separator or method as in any preceding claim, wherein the battery separator comprises two or more conductive additives.

56. A battery separator or method as in any preceding claim, wherein the conductive additive(s) comprise carbon, carbon nanotubes, and/or metallic particles.

57. A battery separator or method as in any preceding claim, wherein the battery separator comprises a conductive coating.

58. A battery separator or method as in any preceding claim, wherein the conductive coating was formed by vapor deposition.

59. A battery separator or method as in any preceding claim, wherein the conductive coating comprises a metallic foil.

60. A battery separator or method as in any preceding claim, wherein the battery separator comprises a sulfation-reducing additive.

61. A battery separator or method as in any preceding claim, wherein the battery separator comprises two or more sulfation-reducing additives.

62. A battery separator or method as in any preceding claim, wherein the sulfation-reducing additive(s) comprise a sulfate salt.

63. A battery separator or method as in any preceding claim, wherein the sulfate salt comprises a monovalent cation.

64. A battery separator or method as in any preceding claim, wherein the sulfate salt comprises a divalent cation.

65. A battery separator or method as in any preceding claim, wherein the sulfate salt comprises sodium sulfate, magnesium sulfate, and/or barium sulfate.

66. A battery separator or method as in any preceding claim, wherein the battery separator comprises an antimony-suppression additive.

67. A battery separator or method as in any preceding claim, wherein the battery separator comprises two or more antimony-suppression additives.

68. A battery separator or method as in any preceding claim, wherein the antimony-suppressing additive(s) comprise a fluorocarbon, a vinyl aldehyde, a ketone, an alkyl phosphonate, and/or natural rubber.

69. A battery separator or method as in any preceding claim, wherein the battery separator comprises a water loss-reducing additive.

70. A battery separator or method as in any preceding claim, wherein the battery separator comprises two or more water loss-reducing additives.

71. A battery separator or method as in any preceding claim, wherein the water loss-reducing additive(s) comprise a sulfate and/or benzylideneacetone.

72. A battery separator or method as in any preceding claim, wherein the sulfate comprises zinc sulfate and/or alkyl ammonium hydrogen sulfate.

73. A battery separator or method as in any preceding claim, wherein the battery separator is positioned in a battery.

74. A battery as in claim 73, wherein the battery is a lead-acid battery.

75. A battery as in claim 73 or 74, wherein the battery is a flooded battery, a gel battery, an extended flooded battery, and/or a VRLA battery.
